(19) United States
(12) Patent Application Publication
(10) Pub. No.: US 2021/0274556 A1
(43) Pub. Date: Sep. 2, 2021

(54) METHOD FOR TRANSMITTING/RECEIVING SIGNAL IN WIRELESS COMMUNICATION SYSTEM, AND DEVICE THEREFOR

(71) Applicant: LG Electronics Inc., Seoul (KR)

(72) Inventors: Changhwan PARK, Seoul (KR); Suckchel YANG, Seoul (KR); Joonkui AHN, Seoul (KR); Seonwook KIM, Seoul (KR); Seunggye HWANG, Seoul (KR)

(21) Appl. No.: 17/254,113

(22) PCT Filed: Aug. 9, 2019
(86) PCT No.: PCT/KR2019/010167

§ 371 Date: Dec. 18, 2020

(30) Foreign Application Priority Data
Aug. 9, 2018 (KR) 10-2018-0093412
Sep. 21, 2018 (KR) 10-2018-0114488
Sep. 27, 2018 (KR) 10-2018-0115382
Nov. 2, 2018 (KR) 10-2018-0134006
Feb. 15, 2019 (KR) 10-2019-0017911

(51) Int. Cl. H04W 74/08; H04W 24/10; H04L 1/00; H04L 1/20

(52) U.S. Cl. CPC H04W 74/0833; H04L 1/203; H04L 1/0026; H04W 24/10

(57) ABSTRACT

The present invention relates to a method for transmitting/receiving downlink quality information in a wireless communication system, and a device therefor and, more particularly, to a method comprising the steps of: transmitting/receiving a random access preamble; transmitting/receiving a random access response on the basis of the random access preamble; and transmitting/receiving downlink quality information through a physical uplink shared channel on the basis of the random access response.

### TECHNICAL FIELD

The present disclosure relates to a wireless communication system, and more particularly, to a method and apparatus for transmitting and receiving downlink (channel) quality information.

### BACKGROUND ART

Mobile communication systems were developed to provide voice services while ensuring mobility of users. However, mobile communication systems have been extended to data services as well as voice services, and more advanced communication systems are needed as the explosive increase in traffic now leads to resource shortages and users demand higher speed services.

Requirements of the next generation mobile communication systems are to support accommodation of explosive data traffics, dramatic increases in throughputs per user, accommodation of significantly increased number of connected devices, very low end-to-end latency, and high energy efficiency. To this end, various technologies such as Dual Connectivity, massive multiple input multiple output (massive MIMO), in-band full duplex, non-orthogonal multiple access (NOMA), support of super wideband, and device networking are under research.

### DISCLOSURE

### Technical Problem

An aspect of the present disclosure is to provide a method and apparatus for efficiently transmitting and receiving downlink (channel) quality information.

Another aspect of the present disclosure is to provide a method and apparatus for efficiently transmitting and receiving downlink (channel) quality information in a random access procedure.

Another aspect of the present disclosure is to provide a method and apparatus for efficiently transmitting and receiving downlink (channel) quality information in a radio resource control (RRC) connected state.

Another aspect of the present disclosure is to provide a method and apparatus for efficiently transmitting and receiving downlink (channel) quality information about a physical downlink control channel (PDCCH) and/or a physical downlink shared channel (PDSCH).

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In an aspect of the present disclosure, a method of transmitting downlink quality information to a base station (BS) by a user equipment (UE) in a wireless communication system includes transmitting a random access preamble to the BS, receiving a random access response from the BS, and transmitting the downlink quality information to the BS through a physical uplink shared channel based on the random access response.

In another aspect of the present disclosure, a UE configured to transmit downlink quality information to a BS in a wireless communication system includes a radio frequency (RF) transceiver and a processor operatively coupled to the RF transceiver. The processor is configured to transmit a random access preamble to the BS, receive a random access response from the BS, and transmit the downlink quality information to the BS through a physical uplink shared channel based on the random access response, by controlling the RF transceiver.

In another aspect of the present disclosure, an apparatus for a UE in a wireless communication system includes a memory including instructions and a processor operatively coupled to the memory. The processor is configured to perform specific operations by executing the instructions. The specific operations include transmitting a random access preamble to a BS, receiving a random access response from the BS, and transmitting downlink quality information to the BS through a physical uplink shared channel based on the random access response.

In another aspect of the present disclosure, a method of receiving downlink quality information from a UE by a BS in a wireless communication system includes receiving a random access preamble from the UE, transmitting a random access response to the UE, and receiving the downlink quality information from the UE through a physical uplink shared channel based on the random access response.

In another aspect of the present disclosure, a BS for receiving downlink quality information from a UE in a wireless communication system includes an RF transceiver and a processor operatively coupled to the RF transceiver. The processor is configured to receive a random access preamble from the UE, transmit a random access response to the UE, and receive the downlink quality information from the UE through a physical uplink shared channel based on the random access response, by controlling the RF transceiver.

In another aspect of the present disclosure, an apparatus for a BS in a wireless communication system includes a memory including instructions and a processor operatively coupled to the memory. The processor is configured to perform specific operations by executing the instructions. The specific operations include receiving a random access preamble from a UE, transmitting a random access response to the UE, and receiving downlink quality information from the UE through a physical uplink shared channel based on the random access response.

The downlink quality information may include information indicating a repetition number of a physical downlink control channel related to the random access response at a time of detecting the physical downlink control channel.

The downlink quality information may further include information indicating an aggregation level of a physical downlink control channel related to the random access response at the time of detecting the physical downlink control channel.

When the repetition number of the physical downlink control channel related to the random access response satisfies a specific performance requirement, the downlink quality information may be transmitted based on an assumption that an AL of the physical downlink control channel is a reference aggregation level.

The specific performance requirement may include the repetition number of the physical downlink control channel being 1.

The downlink quality information may include information indicating a repetition number required to detect a hypothetical physical downlink control channel at a specific block error rate (BLER).

The specific BLER may be 1%.

The downlink quality information may further include information indicating an aggregation level required to detect the hypothetical physical downlink control channel at the specific BLER.

When the repetition number required to detect the hypothetical physical downlink control channel satisfies a specific performance requirement, the downlink quality information may be transmitted based on an assumption that the AL is a reference aggregation level.

The specific performance requirement may include the repetition number required to detect the hypothetical physical downlink control channel being 1.

The random access response may include information indicating the UE to report the downlink quality information.

The downlink quality information may be transmitted by the UE in a radio resource control (RRC) idle state.

The downlink quality information may be measured in a common search space (CSS) for a physical downlink control channel related to the random access response.

### Advantageous Effects

According to the present disclosure, downlink (channel) quality information may be efficiently transmitted and received.

Further, according to the present disclosure, downlink (channel) quality information may be efficiently transmitted and received in a random access procedure.

Further, according to the present disclosure, downlink (channel) quality information may be efficiently transmitted and received in a radio resource control (RRC) connected state.

Further, according to the present disclosure, downlink (channel) quality information about a physical downlink control channel (PDCCH) and/or a physical downlink shared channel (PDSCH) may be efficiently transmitted and received.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a diagram illustrating long term evolution(-advanced) (LTE-(A)) radio frame structures;

FIG. 2 is a diagram illustrating a radio frame structure in new radio access technology (NR);

FIG. 3 is a diagram illustrating a resource grid during one downlink slot in an LTE system;

FIG. 4 is a diagram illustrating a resource grid in NR;

FIG. 5 is a diagram illustrating physical resource blocks (PRBs) in NR;

FIG. 6 is a diagram illustrating available physical channels and a general signal transmission method using the physical channels in machine type communication (MTC);

FIG. 7 is a diagram illustrating available physical channels and a general signal transmission method using the physical channels in narrowband Internet of things (NB-IoT);

FIG. 8 is a diagram illustrating a time flow of channels and signals transmitted/received by a user equipment (UE) in a random access procedure;

FIGS. 9 to 12 are flowcharts illustrating methods performed in a UE and a base station (BS) according to proposals of the present disclosure; and

FIGS. 13 to 18 are block diagrams illustrating a system and communication devices to which proposed methods of the present disclosure are applicable.

### BEST MODE

In the following description, downlink (DL) refers to communication from a base station (BS) to a user equipment (UE), and uplink (UL) refers to communication from the UE to the BS. In the case of DL, a transmitter may be a part of the BS, and a receiver may be a part of the UE. In the case of UL, a transmitter may be a part of the UE, and a receiver may be a part of the BS.

The technology described herein is applicable to various wireless access systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented as radio technology such as universal terrestrial radio access (UTRA) or CDMA2000. The TDMA may be implemented as radio technology such as global system for mobile communications (GSM), general packet radio service (GPRS), or enhanced data rates for GSM evolution (EDGE). The OFDMA may be implemented as radio technology such as the Institute of Electrical and Electronics Engineers (IEEE) 802.11 (Wi-Fi), IEEE 802.16 (WiMAX), IEEE 802-20, evolved UTRA (E-UTRA), etc. The UTRA is a part of a universal mobile telecommunication system (UMTS). The 3rd generation partnership project (3GPP) long term evolution (LTE) is a part of an evolved UMTS (E-UMTS) using the E-UTRA. LTE-advance (LTE-A) or LTE-A pro is an evolved version of the 3GPP LTE. 3GPP new radio or new radio access technology (3GPP NR) or 5G is an evolved version of the 3GPP LTE, LTE-A, or LTE-A pro.

Although the present disclosure is described based on 3GPP communication systems (e.g., LTE-A, NR, etc.) for clarity of description, the spirit of the present disclosure is not limited thereto. The LTE refers to the technology beyond 3GPP technical specification (TS) 36.xxx Release 8. In particular, the LTE technology beyond 3GPP TS 36.xxx Release 10 is referred to as the LTE-A, and the LTE technology beyond 3GPP TS 36.xxx Release 13 is referred to as the LTE-A pro. The 3GPP 5G means the technology beyond TS 36.xxx Release 15 and 3GPP NR refers to the technology beyond 3GPP TS 38.xxx Release 15. The LTE/NR may be called ‘3GPP system’. Herein, “xxx” refers to a standard specification number. The LTE/NR may be commonly referred to as ‘3GPP system’. Details of the background, terminology, abbreviations, etc. used herein may be found in documents published before the present disclosure. For example, the following documents may be referenced.

3GPP LTE
36.211: Physical channels and modulation
36.212: Multiplexing and channel coding
36.213: Physical layer procedures
36.300: Overall description
36.304: User Equipment (UE) procedures in idle mode
36.331: Radio Resource Control (RRC)

3GPP NR
38.211: Physical channels and modulation
38.212: Multiplexing and channel coding
38.213: Physical layer procedures for control
38.214: Physical layer procedures for data
38.300: NR and NG-RAN Overall Description
38.304: User Equipment (UE) procedures in Idle mode and RRC Inactive state
36.331: Radio Resource Control (RRC) protocol specification

Evolved UMTS terrestrial radio access network (E-UTRAN), LTE, LTE-A, LTE-A pro, and 5^{th} generation (5G) systems may be generically called an LTE system. A next generation radio access network (NG-RAN) may be referred to as an NR system. A UE may be fixed or mobile. The term UE is interchangeably used with other terms such as terminal, mobile station (MS), user terminal (UT), subscriber station (SS), mobile terminal (MT), and wireless device. A BS is generally a fixed station communicating with a UE. The term BS is interchangeably used with other terms such as evolved Node B (eNB), general Node B (gNB), base transceiver system (BTS), and access point (AP).

A. Frame Structures

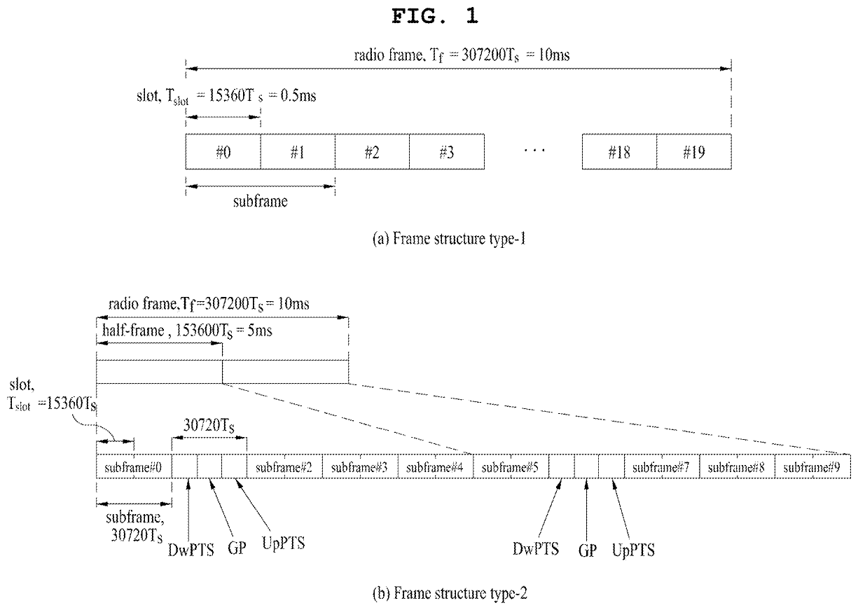

FIG. 1 illustrates radio frame structures in an LTE(-A) system. The LTE(-A) system supports a type-1 radio frame structure for frequency division duplex (FDD) and a type-2 radio frame structure for time division duplex (TDD).

FIG. 1(a) illustrates the type-1 radio frame structure. A DL radio frame is defined by 10 1-ms subframes. A subframe includes 2 slots in the time domain. A time taken to transmit one subframe is referred to as a transmission time interval (TTI). For example, one subframe may be 1 ms in duration, and one slot may be 0.5 ms in duration. One slot includes a plurality of OFDM symbols in the time domain by a plurality of resource blocks (RBs) in the frequency domain. Because the LTE(-A) system adopts OFDM for DL, one OFDM symbol represents one symbol interval. The LTE(-A) system adopts SC-FDMA for UL and thus an OFDM symbol may also be referred to as an SC-FDMA symbol. Further, an OFDM symbol may be generically called a symbol interval. An RB as a resource allocation unit may include a plurality of consecutive subcarriers in one slot.

FIG. 1(b) illustrates the type-2 radio frame structure. The type-2 radio frame includes two half frames, each half frame including five subframes. Each subframe includes a DL period (e.g., downlink pilot time slot (DwPTS)), a guard period (GP), a UL period (e.g., uplink pilot time slot (UpPTS)). One subframe includes two slots. For example, the DL period (e.g., DwPTS) is used for initial cell search, synchronization, or channel estimation at a UE. For example, the UL period (e.g., UpPTS) is used for channel estimation and UL synchronization with a UE at a BS. For example, a sounding reference signal (SRS) for channel estimation and a physical random access channel (PRACH) carrying a random access preamble for acquisition of UL transmission synchronization at the BS may be transmitted during the UL period (e.g., UpPTS). The GP is a period for canceling interference with the UL, caused by the multipath delay of a DL signal between the UL and the DL.

The radio frame structures described above are for illustrative purposes only, and the number of subframes in a radio frame, the number of slots in a subframe, and the number of symbols in a slot may vary.

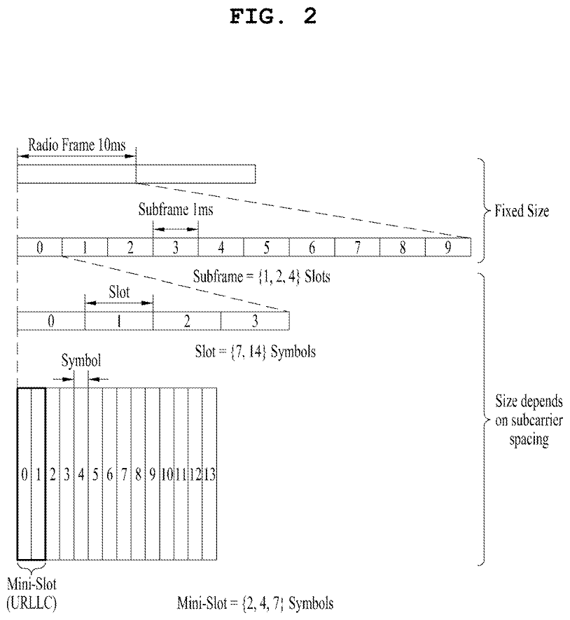

FIG. 2 is a diagram illustrating a frame structure in NR.

The NR system may support multiple numerologies. A numerology may be defined by a subcarrier spacing (SCS) and a cyclic prefix (CP) overhead. Multiple SCSs may be derived by scaling a default SCS by an integer N (or μ). Further, even though it is assumed that a very small SCS is not used in a very high carrier frequency, a numerology to be used may be selected independently of a frequency band. Further, the NR system may support various frame structures according to multiple numerologies.

Now, a description will be given of OFDM numerologies and frame structures which may be considered for the NR system. Multiple OFDM numerologies supported by the NR system may be defined as listed in Table 1.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Regarding a frame structure in the NR system, the time-domain sizes of various fields are represented as multiples of a basic time unit, Tₛ=1/(Δfₘₐₓ·N_{f}) where Δfₘₐₓ=480·10³ and N_{f}=4096. DL and UL transmissions are organized into radio frames each having a duration of Tᵣ=(ΔfₘₐₓN_{f}/100)·Tₛ=10 ms. Each radio frame includes 10 subframes each having a duration of T_{sf}=(ΔfₘₐₓN_{f}/1000)·Tₛ=1 ms. In this case, there may exist one set of frames for UL and one set of frames for DL. Further, transmission of UL frame #i from the UE should state a time T_{TA}=N_{TA}Tₛ before the start of a corresponding DL frame. For a numerology μ, slots are numbered with nₛ^{μ}∈{0, . . . , N_{subframe}^{slots,μ}−1} in an increasing order in a subframe, and with n_{s,f}μ∈{0, . . . , N_{frame}^{slots,μ}−1} in an increasing order in a radio frame. One slot includes N^{μ}_{symb} consecutive OFDM symbols, and N^{μ}_{symb} depends on a used numerology and slot configuration. The start of a slot nₛ^{μ} in a subframe is aligned in time with the start of an OFDM symbol nₛ^{μ}N_{symb}^{μ} in the same subframe. All UEs are not capable of simultaneous transmission and reception, which implies that all OFDM symbols of a DL slot or a UL slot may not be used. Table 2 lists the number N_{symb}^{slot} of symbols per slot, the number Nₛₗₒₜ^{frameμ} of slots per frame, and the number Nₛₗₒₜ^{subframeμ} of slots per subframe, for each SCS in a normal CP case, and Table 3 lists the number of symbols per slot, the number of slots per frame, and the number of slots per subframe, for each SCS in an extended CP case.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

FIG. 2 illustrates an example with μ=2, that is, an SCS of 60 kHz, in which referring to Table 2 one subframe may include four slots. One subframe={1, 2, 4} slots in FIG. 2 which is exemplary, and the number of slot(s) which may be included in one subframe is defined as listed in Table 2.

Further, a mini-slot may include 2, 4 or 7 symbols, fewer symbols than 2, or more symbols than 7.

B. Physical Resources

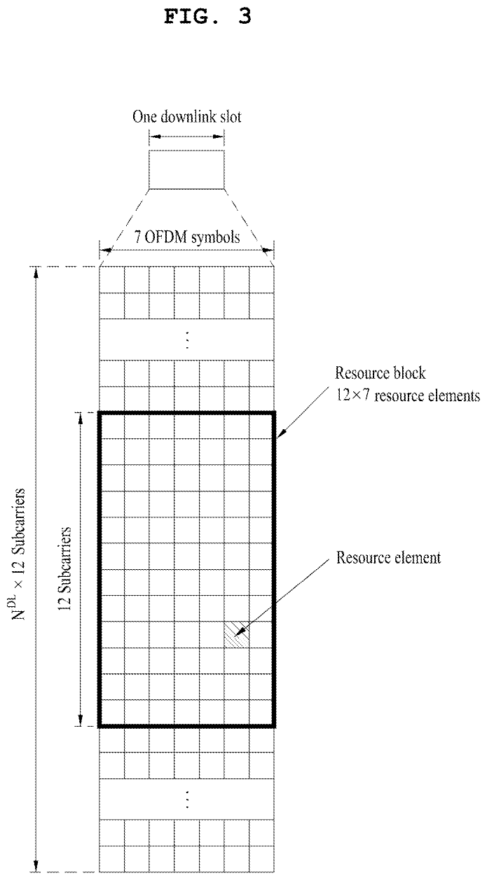

FIG. 3 illustrates a resource grid for the duration of one DL slot in the LTE system.

In FIG. 3, a DL slot includes a plurality of OFDM symbols in the time domain. One DL slot includes 7 OFDM symbols, and an RB includes, for example, 12 subcarriers in the frequency domain, which does not limit the present disclosure. Each element of the resource grid is referred to as a resource element (RE). An RB includes 12×7 REs. The number of RBs in a DL slot, NDL depends on a DL transmission bandwidth. A UL slot may have the same structure as a DL slot.

Up to three OFDM symbols at the start of the first slot in a subframe are used for a control region to which control channels are allocated, and the other OFDM symbols of the subframe are used for a data region to which a physical downlink shared channel (PDSCH) is allocated. DL control channels used in the 3GPP LTE system include a physical control format indicator channel (PCFICH), a physical downlink control channel (PDCCH), and a physical hybrid automatic repeat request (HARQ) indicator channel (PHICH). The PCFICH is located in the first OFDM symbol of a subframe, carrying information about the number of OFDM symbols used for transmission of control channels in the subframe. The PHICH is a response to a UL transmission, delivering an HARQ acknowledgment/negative acknowledgment (ACK/NACK) signal. Control information carried on the PDCCH is called downlink control information (DCI). The DCI includes UL or DL scheduling information or a UL transmission (Tx) power control commands for any UE group. The PDCCH delivers a resource assignment for a downlink shared channel (DL-SCH), resource allocation information about an uplink shared channel (UL-SCH), paging information of a paging channel (PCH), a random access response transmitted on the PDSCH, a set of Tx power control commands for individual UEs of a UE group, a Tx power control information, and DL-SCH voice over Internet protocol (VoIP) activation information being a resource assignment for a higher-layer control message such as Tx power command activation. A plurality of PDCCHs may be transmitted in the control region. A UE may monitor a plurality of PDCCHs. A PDCCH is formed by aggregating one or more consecutive control channel elements (CCEs). A CCE is a logical allocation unit used to provide a PDCCH at a coding rate based on the state of a radio channel. A CCE corresponds to a plurality of RE groups. The format of a PDCCH and the number of available bits for the PDCCH are determined according to the correlation between the number of CCEs and a coding rate provided by the CCEs. An eNB determines the PDCCH format according to DCI transmitted to a UE and adds a cyclic redundancy check (CRC) to the control information. The CRC is masked by an identifier (ID) known as a radio network temporary identifier (RNTI) according to the owner or usage of the PDCCH. If the PDCCH is directed to a specific UE, its CRC may be masked by a unique ID (e.g., cell-RNTI (C-RNTI)) of the UE. Alternatively, if the PDCCH is for a paging message, the CRC of the PDCCH may be masked by a paging indicator identifier (P-RNTI). If the PDC CH carries system information (particularly, a system information block (SIB) described later), its CRC may be masked by a system information ID and a system information RNTI (SI-RNTI). To indicate that the PDCCH carries a random access response to a random access preamble transmitted by a UE, its CRC may be masked by a random access-RNTI (RA-RNTI).

A UL subframe may be divided into a control region and a data region in the frequency domain. A physical uplink control channel (PUCCH) carrying uplink control information (UCI) is allocated to the control region, and a physical uplink shared channel (PUSCH) carrying user data is allocated to the data region. To maintain the single carrier property, a UE does not transmit a PUSCH and a PUCCH simultaneously. A PUCCH for a UE is allocated to an RB pair in a subframe. The RBs of the RB pair occupy different subcarriers in two slots. Thus it is said that the RB pair allocated to the PUCCH is frequency-hopped over a slot boundary.

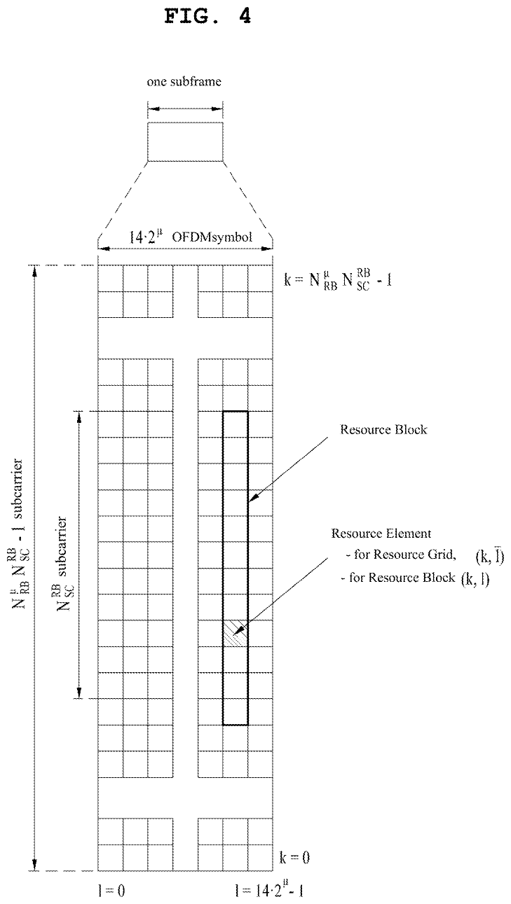

FIG. 4 illustrates a resource grid in the NR system.

Referring to FIG. 4, a resource grid includes N_{RB}^{μ}N_{sc}^{RB} subcarriers in the time domain, and one subframe 14·2μ OFDM symbols, which is exemplary and thus should not be construed as limiting the disclosure. In the NR system, a transmitted signal is described by one or more resource grids including N_{RB}^{μ}N_{sc}^{RB} subcarriers and 2^{μ}N_{symb}^{(μ)} OFDM symbols, where N_{RB}^{μ}≤N_{RB}^{max,μ}. N_{RB}^{max,μ} represents a maximum transmission bandwidth, which may be different for UL and DL as well as according to numerologies. In this case, one resource grid may be configured for each neurology μ and each antenna port p, as illustrated in FIG. 4. Each element of the resource grid for the numerology μ and the antenna port p is referred to as an RE, which is uniquely identified by an index pair (k,l̅) where k=0, . . . , N_{RB}^{μ}N_{sc}^{RB}−1 is a frequency-domain index and l̅=0, . . . , 2^{μ}N_{symb}^{(μ)}−1 indicates the position of a symbol in a subframe. An RE in a slot is indicated by an index pair (k,l) where l=0, . . . , N^{μ}_{symb}−1. An RE (k,l̅) for the numerology μ and the antenna port p corresponds to a complex value a_{k,l̅}^{(p,μ)}. When there is no risk of confusion or a specific antenna port or a numerology is not specified, the indexes p and μ may be dropped, and as a result, the complex value may be a_{k,l̅}^{(p)} or a_{k,l̅}. In addition, an RB is defined as N_{sc}^{RB}=12 consecutive subcarriers in the frequency domain.

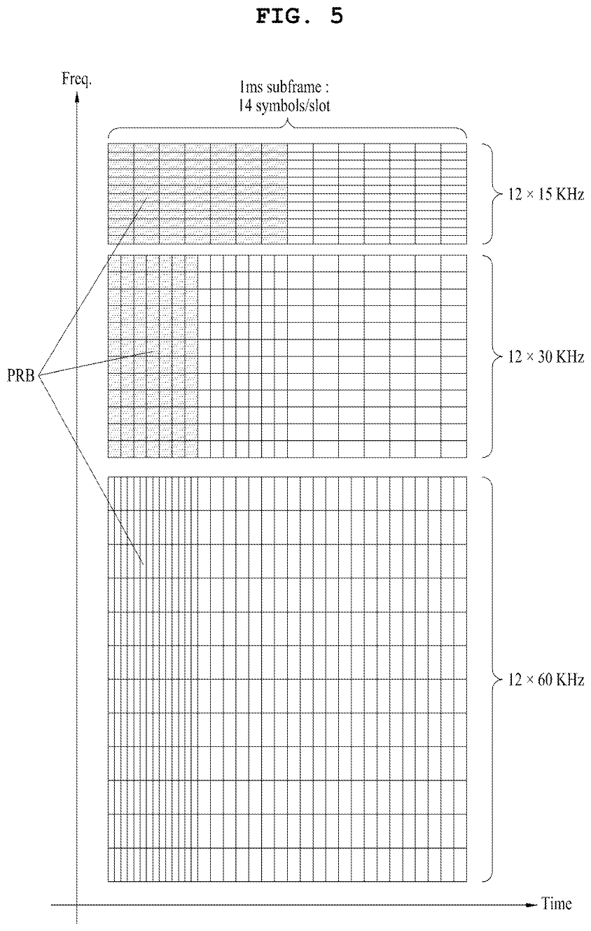

FIG. 5 illustrates exemplary physical resource blocks (PRBs) in NR.

C. Machine Type Communication (MTC)

MTC is an application that does not require a lot of throughput, applicable to machine-to-machine (M2M) or Internet of things (IoT). MTC is also a communication technology adopted to meet the requirements of IoT service in the 3GPP.

MTC may be implemented to satisfy (i) low cost and low complexity, (ii) enhanced coverage, and (iii) low power consumption.

While the following description will be given mainly in the context of enhanced MTC (eMTC) features, the same thing may be applied to MTC, eMTC, and MTC applied to 5G (or NR) unless otherwise specified. For the convenience of description, MTC, eMTC, and MTC applied to 5G (or NR) will be generically referred to as MTC.

Therefore, MTC to be described later may be replaced with other terms such as eMTC, LTE-M1/M2, bandwidth reduced low complexity (BL)/coverage enhanced (CE), non-BL UE (in enhanced coverage), NR MTC, enhanced BL/CE, and so on. That is, the term MTC may be replaced with a term to be defined in the future 3GPP standard.

Overview of MTC

(1) MTC operates only in a specific system bandwidth (or channel bandwidth).

The specific system bandwidth may be 6 RBs of legacy LTE, and may be defined in consideration of NR frequency ranges and SCSs defined in Table 4, Table 5, and Table 6. The specific system bandwidth may be represented as a narrowband (NB). For reference, legacy LTE refers to a part described in the 3GPP standards other than MTC. Preferably, MTC may operate in RBs corresponding to the lowest system bandwidth in Table 5 and Table 6 below in NR, as in legacy LTE. Alternatively, MTC may operate in at least one bandwidth part (BWP) or in a specific band of the BWP in NR.

Table 4 lists frequency ranges (FRs) defined in NR.

TABLE 4

| Frequency range | |
|---|---|
| designation | Corresponding frequency range |
| FR1 | 450 MHz-6000 MHz |
| FR2 | 24250 MHz-52600 MHz |

Table 5 illustrates an exemplary maximum transmission bandwidth configuration (NRB) for channel bandwidths and SCSs in FR1 of NR.

TABLE 5

| | 5 | 10 | 15 | 20 | 25 | 30 | 40 | 50 | 60 | 80 | 90 | 100 |
|---|---|---|---|---|---|---|---|---|---|---|---|---|
| SCS | MHz | MHz | MHz | MHz | MHz | MHz | MHz | MHz | MHz | MHz | MHz | MHz |
| (kHz) | NRB | NRB | NRB | NRB | NRB | NRB | NRB | NRB | NRB | NRB | NRB | NRB |
| 15 | 25 | 52 | 79 | 106 | 133 | 160 | 216 | 270 | N/A | N/A | N/A | N/A |
| 30 | 11 | 24 | 38 | 51 | 65 | 78 | 106 | 133 | 162 | 217 | 245 | 273 |
| 60 | N/A | 11 | 18 | 24 | 31 | 38 | 51 | 65 | 79 | 107 | 121 | 135 |

Table 6 illustrates an exemplary maximum transmission bandwidth configuration (NRB) for channel bandwidths and SCSs in FR2 of NR.

TABLE 6

| SCS | 50 MHz | 100 MHz | 200 MHz | 400 MHz |
|---|---|---|---|---|
| (kHz) | NRB | NRB | NRB | NRB |
| 60 | 66 | 132 | 264 | N.A |
| 120 | 32 | 66 | 132 | 264 |

An MTC NB will be described in more detail.

MTC follows an NB operation to transmit and receive physical channels and signals, and the maximum channel bandwidth is reduced to 1.08 MHz or 6 (LTE) RBs. The NB may be used as a reference unit for a resource allocation unit of some DL and UL channels, and the physical position of each NB in the frequency domain may be defined differently according to a system bandwidth. The bandwidth of 1.08 MHz is defined for MTC to enable an MTC UE to follow the same cell search and random access procedure as used for a legacy UE. Although MTC may be supported by a cell with a much larger bandwidth (e.g. 10 MHz) than 1.08 MHz, physical channels and signals transmitted/received by MTC are always limited to 1.08 MHz. The system with a much larger bandwidth may be the legacy LTE system, the NR system, the 5G system, or the like.

An NB is defined as 6 non-overlapping consecutive PRBs in the frequency domain. If N_{NB}^{UL}≥4, a wideband is defined as 4 non-overlapping NBs in the frequency domain. If N_{NB}^{UL}<4, N_{WB}^{UL}=1 and a single wideband includes N_{NB}^{UL} non-overlapping NB (s). For example, in the case of a 10-MHz channel (50 RBs), a single wideband is defined as 8 non-overlapping NBs.

(2) MTC operates in a half-duplex mode and uses limited (or reduced) maximum transmission power.

(3) MTC does not use a channel that should be distributed over the entire system bandwidth of legacy LTE or NR (defined in legacy LTE or NR).

For example, legacy LTE channels which are not used for MTC are the PCFICH, the PHICH, and the PDCCH. Accordingly, these channels may not be monitored and thus a new control channel, MTC PDCCH (MPDCCH) is defined in MTC. The MPDCCH spans up to 6 RBs in the frequency domain and one subframe in the time domain. The MPDCCH is similar to the enhanced PDCCH (EPDCCH), and additionally supports a common search space (CSS) for paging and random access.

(4) MTC uses newly defined DCI formats. For example, the newly defined DCI formats may be DCI formats 6-0A, 6-0B, 6-1A, 6-1B, and 6-2.

(5) In MTC, a physical broadcast channel (PBCH), a PRACH, an MTC physical downlink control channel (MPDCCH), a PDSCH, a PUCCH, and a PUSCH may be repeatedly transmitted. Such MTC repeated transmissions enable decoding of the MTC channels even when signal quality or power is very poor as in a poor environment like a basement, thereby increasing a cell radius and bringing the effect of signal penetration. MTC may support only a limited number of transmission modes (TMs) which may operate in a single layer (or with a single antenna), or a channel or reference signal (RS) that may operate in a single layer. For example, the TMs available for MTC may be TM 1, 2, 6 or 9.

(6) HARQ retransmission of MTC is adaptive and asynchronous, and is based on a new scheduling assignment received on the MPDCCH.

(7) In MTC, PDSCH scheduling (DCI) and PDSCH transmission take place in different subframes (cross-subframe scheduling).

(8) All resource allocation information (a subframe, a transport block size (TBS), and a subband index) for SIB1 decoding is determined by parameters of a master information block (MIB), and no control channel is used for SIB1 decoding of MTC.

(9) All resource allocation information (subframe, TBS, subband index) for SIB2 decoding is determined by several SIB1 parameters, and no control channel is used for SIB2 decoding of MTC.

(10) MTC supports an extended paging (discontinuous reception (DRX)) cycle.

(11) The same primary synchronization signal (PSS)/secondary synchronization signal (SSS)/common reference signal (CRS) as used in legacy LTE or NR may be used in MTC. In NR, the PSS/SSS is transmitted in each SS block (SS/PBCH block or SSB), and a tracking RS (TRS) may be used for the same purpose as the CRS. That is, the TRS, which is a cell-specific RS, may be used for frequency/time tracking.

2) MTC Operation Modes and Levels

Now, MTC operations modes and levels will be described. For CE, two operation modes (first and second modes) and four different levels are defined in MTC, as listed in Table 7.

The MTC operations modes are referred to as CE modes. In this case, the first mode may be referred to as CE Mode A, and the second mode may be referred to as CE Mode B.

TABLE 7

| Mode | Level | Description |
|---|---|---|
| Mode A | Level 1 | No repetition for PRACH |
| | Level 2 | Small Number of Repetition for PRACH |
| Mode B | Level 3 | Medium Number of Repetition for PRACH |
| | Level 4 | Large Number of Repetition for PRACH |

The first mode is defined for small CE, supporting full mobility and CSI feedback, in which no repetition or a small number of repetitions are performed. A first-mode operation may be identical to the operation range of UE category 1. The second mode (e.g., CE Mode B) is defined for UEs in an extremely poor coverage condition, supporting CSI feedback and limited mobility, in which a large number of repeated transmissions are defined. The second mode provides up to 15 dB of CE with respect to the range of UE category 1. Each level of MTC is defined differently for an RACH procedure and a paging procedure.

A method of determining an MTC operation mode and each level will be described below.

An MTC operation mode is determined by the BS, and each level is determined by the MTC UE. Specifically, the BS transmits RRC signaling including information about the MTC operation mode to the UE. The RRC signaling may be an RRC connection setup message, an RRC connection reconfiguration message, or an RRC connection reestablishment message. The term message may be replaced with information element (IE).

Subsequently, the MTC UE determines a level within each operation mode and transmits the determined level to the BS. Specifically, the MTC UE determines the level in the operation mode based on a measured channel quality (e.g., reference signal received power (RSRP), reference signal received quality (RSRQ) or signal to interference and noise ratio (SINR)), and indicates the determined level by using PRACH resources (frequency, time, or a preamble) corresponding to the determined level.

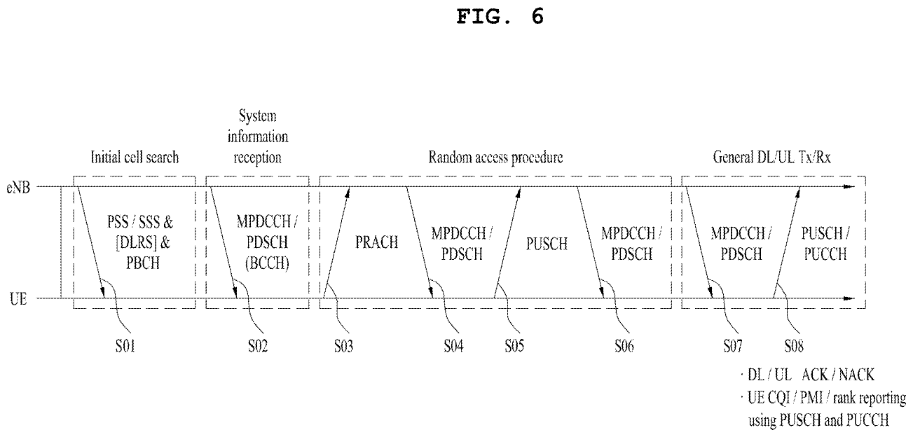

FIG. 6 is a diagram illustrating available physical channels and a general signal transmission method using the physical channels in MTC.

When an MTC UE is powered on or enters a new cell, the MTC UE performs initial cell search including acquisition of synchronization with a BS in step S01. For the initial cell search, the MTC UE synchronizes its timing with the BS and acquires information such as a cell identifier (ID) by receiving a primary synchronization signal (PSS) and a secondary synchronization signal (SSS) from the BS. The PSS/SSS used for the initial cell search in MTC may be the PSS/SSS and resynchronization signal (RSS) in legacy LTE.

The UE may then acquire information broadcast in the cell by receiving a PBCH from the BS. During the initial cell search, the MTC UE may further monitor a DL channel state by receiving a downlink reference signal (DL RS). The information broadcast on the PBCH is an MIB. In MTC, the MIB is repeated in the first slot of subframe subframe #0 of a radio frame and another subframe (subframe #9 in FDD and subframe #5 in TDD) of the radio frame. The PBCH repetition is performed by repeating exactly the same constellation point in different OFDM symbols so that the PBCH repetition may be used for initial frequency error estimation even before PBCH decoding is attempted.

After the initial cell search, the MTC UE may acquire more detailed system information by receiving an MPDCCH and receiving an MPDSCH corresponding to the MPDCCH in step S02. (1) The MPDCCH is very similar to the EPDCCH and delivers common signaling and UE-specific signaling; (2) the MPDCCH may be transmitted only once or repeatedly (a repetition number is configured by higher-layer signaling); (3) a plurality of MPDCCHs are supported, and the UE monitors a set of MPDCCHs; (4) the MPDCCH is generated by combining enhanced control channel elements (eCCEs), each eCCE including a set of REs; and (5) the MPDCCH supports an RA-RNTI, an SI-RNTI, a P-RNTI, a C-RNTI, a temporary C-RNTI, and a semi-persistent scheduling (SPS) C-RNTI.

Subsequently, to complete the connection to the BS, the MTC UE may perform a random access procedure as in steps S03 to S06. A basic configuration related to the RACH procedure is transmitted by SIB2. The MTC UE may transmit a random access preamble on a PRACH in step S03 and receive an MPDCCH and a random access response (RAR) to the preamble on a PDSCH corresponding to the MPDCCH in step S04. In contention-based random access, the MTC UE may perform a contention resolution procedure including transmission of an additional PRACH signal in step S05 and reception of an MPDCCH and a PDSCH corresponding to the MPDCCH in step S06. Signals and/or messages (Msg1, Msg2, Msg3, and Msg4) transmitted in the RACH procedure may be repeatedly transmitted in MTC, and a different repetition pattern is configured according to a CE level. Msg1 may be a PRACH preamble, Msg2 may be an RAR, Msg3 may be a UL transmission of the MTC UE in response to the RAR, and Msg4 may be a DL transmission from the BS in response to Msg3.

The MTC UE measures an RSRP using a DL RS (e.g., CRS, CSI-RS, TRS, and so on) and selects one of random access resources based on the measurement result. Each of four random access resources is related to a repetition number for the PRACH and a repetition number of the RAR. Therefore, an MTC UE with bad coverage needs a large number of repetitions to be successfully detected by the BS and needs to receive an RAR with a corresponding repetition number to satisfy the coverage level of the repetitions.

Search spaces for the RAR and contention resolution messages are also defined by system information and independent of each coverage level.

After the above procedure, the MTC UE may receive an MPDCCH and/or a PDSCH from the BS in step S07 and transmit a PUSCH and/or a PUCCH to the BS in step S08 in a general UL/DL signal transmission procedure. Control information that the MTC UE transmits to the BS is generically called UCI. The UCI includes an HARQ ACK/NACK, a scheduling request (SR), a channel quality indicator (CQI), a precoding matrix indicator (PMI), a rank indication (RI), and so on.

When the RRC connection to the MTC UE is established, the MTC UE blind-decodes the MPDCCH in a search space configured to obtain UL and DL downlink data allocation. In MTC, all OFDM symbols available in a subframe are used to transmit DCI. Therefore, time-domain multiplexing between a control channel and a data channel in the same subframe is impossible. That is, as described before, cross-subframe scheduling between the control channel and the data channel is possible. The MPDCCH repeated for the last time in subframe #N schedules PDSCH allocation in subframe #N+2. DCI transmitted by the MPDCCH provides information about the number of times the MPDCCH is repeated so that when PDSCH transmission starts, the MTC UE may be aware of the PDSCH transmission. The PDSCH allocation may be performed in different NBs. For UL data transmission, scheduling is based on the same timing as that of legacy LTE. The last MPDCCH in subframe #N schedules a PUSCH transmission starting in subframe #N+4.

In legacy LTE, allocation is scheduled by the PDCCH, using the first OFDM symbols of each subframe, and the PDSCH is scheduled in the same subframe in which the PDCCH is received. In contrast, the MTC PDSCH is cross-frame-scheduled, and one subframe is defined between the MPDCCH and the PDSCH to allow MPDCCH decoding and RF retuning. The MTC control channel and data channels may be repeated over a large number of subframes, up to 256 subframes for the MPDCCH and up to 2048 subframes for the PDSCH, so that they may be decoded under extreme coverage conditions.

D. Narrowband-Internet of Things (NB-IoT)

NB-IoT may refer to a system supporting low complexity and low power consumption in a system bandwidth (BW) corresponding to one PRB of a wireless communication system (e.g., LTE system, NR system, or the like).

NB-IoT is interchangeably used with other terms such as NB-LTE, NB-IoT enhancement, enhanced NB-IoT, further enhanced NB-IoT, NB-NR, and so on. That is, NB-IoT may be replaced with a term defined or to be defined in the 3GPP standards. Hereinafter, the term “NB-IoT” will be used for the convenience of description.

NB-IoT is mainly MTC may be used as a communication technique for implementing IoT by supporting MTC devices (or UEs) in a cellular system. As one PRB of the legacy system band is allocated for NB-IoT, frequency may be efficiently used. Further, since each UE perceives a single PRB as a carrier in NB-IoT, the terms PRB and carrier may be interpreted as the same meaning in the disclosure.

While frame structures, physical channels, multi-carrier operations, operation modes, general signal transmission/reception, and so on related to NB-IoT are described in the context of the legacy LTE system in the disclosure, they may also be extended to a future-generation system (e.g., NR system). Further, the description related to NB-IoT in the present disclosure may be extended to MTC serving a similar technical purpose (e.g., low power, low cost, CE, and so on).

1) Frame Structure and Physical Resources of NB-IoT

A different NB-IoT frame structure may be configured according to an SCS. For example, the NB-IoT system may support a 15 kHz SCS and a 3.75 kHz SCS. NB-IoT may be considered for any other SCS (e.g., 30 kHz) with different time/frequency units, not limited to the 15 kHz SCS and the 3.75 kHz SCS. While the NB-IoT frame structure based on the LTE system frame structure has been described herein for the convenience of description, the present disclosure is not limited thereto. Obviously, methods described in the present disclosure may be extended to NB-IoT based on a frame structure of the next-generation system (e.g., NR system).

An NB-IoT frame structure for the 15 kHz SCS may be configured to be identical to the frame structure of the above-described legacy system (i.e., LTE system). That is, a 10-ms NB-IoT frame may include 10 1-ms NB-IoT subframes, each including two 0.5-ms NB-IoT slots. Each 0.5-ms NB-IoT slot may include 7 OFDM symbols.

For the 3.75 kHz SCS, a 10-ms NB-IoT frame includes 5 2-ms NB-IoT subframes, each including 7 OFDM symbols and one guard period (GP). A 2-ms NB-IoT subframe may also be referred to as an NB-IoT slot or an NB-IoT resource unit (RU).

NB-IoT DL physical resources may be configured based on the configuration of physical resources in another wireless communication system (e.g., LTE or NR), except that an NR system bandwidth is a certain number of RBs (e.g., one RB, i.e., 180 kHz). For example, when the NB-IoT DL supports only the 15 kHz SCS, the NB-IoT DL physical resources may be configured as the resource area of one RB (i.e., one PRB) in the frequency domain, to which the resource grid of the LTE system illustrated in FIG. 4 is limited, as described above. Likewise, for NB-IoT UL physical resources, the system bandwidth may be limited to one RB.

2) NB-IoT Physical Channels

A BS and/or a UE supporting NB-IoT may be configured to transmit and receive physical channels and/or physical signals configured separately from the legacy system. For NB-IoT DL, OFDMA may be adopted with a 15 kHz SCS. The resulting orthogonality between subcarriers may lead to efficient support of co-existence with the legacy system (e.g., the LTE or NR system).

Physical channels in the NB-IoT system may be named with an addition of “Narrowband (N)” to be distinguished from those in the legacy system. For example, NB-IoT DL physical channels may include narrowband physical broadcast channel (NPBCH), narrowband physical downlink control channel (NPDCCH), narrowband physical downlink shared channel (NPDSCH), and so on. NB-IoT DL physical signals may include narrowband primary synchronization signal (NPSS), narrowband secondary synchronization signal (NSSS), narrowband reference signal (NRS), narrowband positioning reference signal (NPRS), narrowband wake up signal (NWUS), and so on. For example, NB-IoT UL physical channels include narrowband physical random access channel (NPRACH) and narrowband physical uplink shared channel (NPUSCH), and NB-IoT UL physical signals include narrowband demodulation reference signal (NDMRS).

In the NB-IoT system, the DL channels, NPBCH, NPDCCH, and NPDSCH may be repeatedly transmitted, for CE. Further, NB-IoT uses newly defined DIC formats, for example, DCI format NO. DCI format N1, and DCI format N2.

SC-FDMA may be applied to NB-IoT UL based on an SCS of 15 kHz or 3.75 kHz. Multi-tone transmission and single-tone transmission may be supported for the NB-IoT UL. For example, multi-tone transmission is supported only for the 15 kHz SCS, and single-tone transmission may be supported for the SCSs of 15 kHz and 3.75 kHz. The NPUSCH may be configured in NPUSCH format 1 or NPUSCH format 2. For example, NPUSCH format 1 may be used to carry (or deliver) a UL-SCH, and NPUSCH format 2 may be used to transmit UCI such as an HARQ ACK.

Characteristically, the UL channel of the NB-IoT system, NPRACH may be repeatedly transmitted, for CE. In this case, frequency hopping may be applied to the repeated transmissions.

3) NB-IoT Multi-Carrier Operation

NB-IoT may operate in a multi-carrier mode as described before. In NB-IoT, a carrier may be defined as an anchor type carrier (i.e., anchor carrier or anchor PRB) or a non-anchor type carrier (i.e., non-anchor carrier or non-anchor PRB).

From the perspective of a BS, the anchor carrier may mean a carrier carrying an NPSS, an NSSS, and an NPBCH for initial access, and an NPDSCH for a narrowband system information block (N-SIB). That is, in NB-IoT, a carrier for initial access may be referred to as an anchor carrier, and the other carrier(s) may be referred to as non-anchor carrier(s). One or more anchor carriers may exist in the system.

4) General Signal Transmission and Reception Procedure in NB-IoT

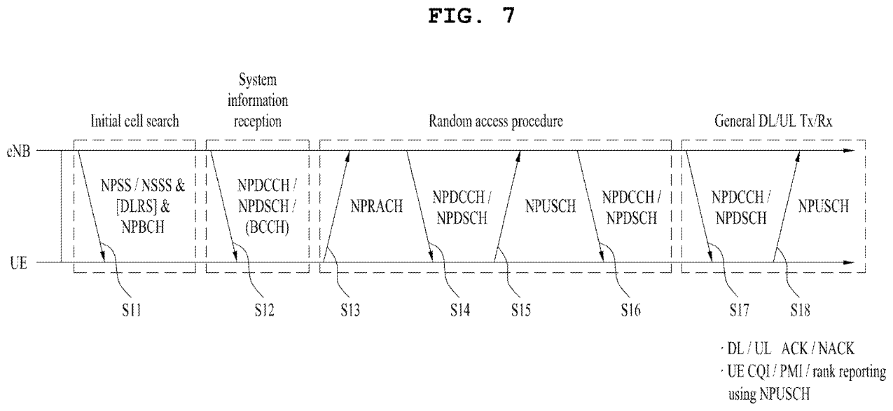

FIG. 7 illustrates available physical channels and a general signal transmission method using the physical channels in NB-IoT. In a wireless communication system, an NB-IoT UE may receive information from a BS on DL and transmit information to the BS on UL. In other words, the BS may transmit information to the NB-IoT UE on DL, and receive information from the NB-IoT UE on UL.

The information transmitted and received between the BS and the NB-IoT UE includes data and various types of control information, and various physical channels may exist according to the type/use of information transmitted and received by the BS and the NB-IoT UE. A method of transmitting and receiving an NB-IoT signal described with reference to FIG. 7 may be performed by the above-described wireless communication devices.

When an NB-IoT UE is powered on or enters a new cell, the NB-IoT UE performs initial cell search including acquisition of synchronization with a BS (S11). For the initial cell search, the NB-IoT UE synchronizes its timing with the BS and acquires information such as a cell ID by receiving a PSS and an SSS from the BS. The NB-IoT UE may further acquire information broadcast in the cell by receiving a NPBCH from the BS. During the initial cell search, the NB-IoT UE may further monitor a DL channel state by receiving a DL RS.

In other words, when there is any new NB-IoT UE which has entered the cell, the BS may perform the initial cell search operation including synchronization with the NB-IoT UE. The BS may synchronize its timing with the NB-IoT UE by transmitting the NPSS and the NSSS to the NB-IoT UE and transmit information such as the cell ID to the NB-IoT UE. Further, the BS may transmit the information broadcast in the cell to the NB-IoT UE by transmitting (broadcasting) the DL RS to the NB-IoT UE during the initial cell search.

After the initial cell search, the NB-IoT UE may acquire more detailed system information by receiving an NPDCCH and receiving an NPDSCH corresponding to the NPDCCH (S12). In other words, the BS may transmit the more detailed system information to the NB-IoT UE which has completed the initial cell search by transmitting the NPDCCH and the NPDSCH corresponding to the NPDCCH. Subsequently, to complete the connection to the BS, the NB-IoT UE may perform a random access procedure (S13 to S16). Specifically, the NB-IoT UE may transmit a random access preamble on an NPRACH S13). As described before, the NPRACH may be configured to be transmitted repeatedly based on frequency hopping for CE. In other words, the BS may receive the preamble (repeatedly) on the NPRACH from the NB-IoT UE. Then, the NB-IoT UE may receive an NPDCCH and an RAR for the preamble on an NPDSCH corresponding to the NPDCCH (S14). In other words, the BS may transmit the NPDCCH and then the RAR for the preamble on the NPDSCH corresponding to the NPDCCH to the NB-IoT UE. Then, the NB-IoT UE may transmit an NPUSCH to the BS by using scheduling information included in the RAR (S15) and perform a contention resolution procedure involving an NPDCCH and an NPDSCH corresponding to the NPDCCH (S16). In other words, the BS may receive the NPUSCH from the NB-IoT UE based on the scheduling information in the RAR and perform the contention resolution procedure.

After the above procedure, the NB-IoT UE may receive an NPDCCH and/or an NPDSCH from the BS (S17) and transmit an NPUSCH to the BS (S18) in a general UL/DL signal transmission procedure. In other words, after the above procedure, the BS may transmit the NPDCCH and/or the NPDSCH to the NB-IoT UE and receive the NPUSCH from the NB-IoT UE in the general UL/DL signal transmission procedure. As mentioned before, the NPBCH, the NPDCCH, and the NPDSCH may be transmitted repeatedly, for CE. Further, in NB-IoT, a UL-SCH (i.e., general UL data) and UCI may be delivered on the NPUSCH. The UL-SCH and the UCI may be configured to be transmitted in different NPUSCH formats (e.g., NPUSCH format 1 and NPUSCH format 2).

E. Proposed Methods of the Present Disclosure

The present disclosure makes proposals in relation to a procedure of reporting a DL signal/channel quality in a random access procedure.

In general, a UE does not measure a channel quality in a random access procedure (or when DCI triggers CFRA in the RRC_CONNECTED state, CQI reporting in Msg3 may be indicated). Therefore, a BS performs DL scheduling in a conservative manner until before an RRC connection is established. A system supporting CE (e.g., MTC and NB-IoT) or a non-bandwidth reduced and low complexity (non-BL) UE (or legacy LTE UE) supporting a CE mode is characterized by repeated transmissions, and thus conservative DL scheduling even in the random access procedure may result in waste of too much resources.

In view of its nature (main services being metering and reporting), a system such as MTC and NB-IoT is expected to be inoperative for long in the RRC connected mode (or RRC_CONNECTED state). Accordingly, reporting downlink (channel) quality information (DQI) as early as possible before the RRC connected mode may be favorable to the network and the UE in terms of resource use efficiency and power saving. In this context, the present disclosure proposes an early DQI reporting method for efficiently helping with DL scheduling of a BS in a random access procedure. To minimize modifications to the legacy random access procedure, the present disclosure relates to a method and procedure for a network to provide, through system information and the Msg2 step, information which is required for a CQI report in Msg3.

Considering that the present disclosure will bring the greatest effect to a system characterized by repeated transmissions such as NB-IoT and MTC (or a BL/CE UE and a CE-mode UE), the present disclosure will be described in the context of NB-IoT and MTC, for convenience. That is, proposed techniques of the present disclosure may also be applied to a system in which repeated transmissions are not performed or a general communication system. Besides, when the proposed methods are operatively almost the same between NB-IoT and MTC, the present disclosure is described mainly in the context of NB-IoT, for convenience. However, the present disclosure is also applicable to a UE requiring a reduced bandwidth, low complexity, or CE (e.g., an MTC UE or a BL/CE UE) and a related system, not limited to NB-IoT.

The above descriptions (of the 3GPP system, the frame structures, the MTC/NB-IoT system, and so on) may be applied in combination with the proposed methods of the present disclosure described below or used to clarify the technical features of the proposed methods of the present disclosure.

Abbreviations

ACK/NACK: Acknowledgement/Negative-Acknowledgement

AL: Aggregation Level

BER: Bit Error Rate

BLER: Block Error Rate

GE: Coverage Enhancement (or Coverage Extension)

BL/CE: Bandwidth reduced Low cost Coverage Enhanced or Extended

CBRA: Contention Based Random Access

CCE: Control Channel Element

CE: Coverage Extension or Enhancement

CFRA: Contention Free Random Access

CQI: Channel Quality Information

CRS: Common or Cell-specific Reference Signal

CSI: Channel State Information

CSS: Common Search Space

DCI: Downlink Control Information

DMRS: DeModulation Reference Signal

DQI: Downlink (channel) Quality Information

DQI-RS: DQI-Reference reSource

ECCE: Enhanced Control Channel Element

EDT: Early Data Transmission

eMTC: enhanced Machine Type Communication

HARQ: Hybrid Automatic Repeat reQuest

MAC: Medium Access Control

MCS: Modulation and Coding Scheme

MTC: Machine Type Communication

NB: NarrowBand

NRS: Narrowband Reference Signal

PMI: Precoding Matrix Indicator

PRB: Physical Resource Block

QAM: Quadrature Amplitude Modulation

R: Repetition number

RAR: Random Access Response

PUR: Preconfigured Uplink Resource

RB: Resource Block

RE: Resource Element

RI: Rank indicator

RLM: Radio Link Monitoring

RRC: Radio Resource Control

RSRP: Reference Signal Received Power

RSRQ: Reference Signal Received Quality

RSSI: Received Signal Strength Indicator

SIB: System Information Block

SNR: Signal-to-Noise Ratio

SPS: Semi-Persistent Scheduling

TA: Timing Advance

TBS: Transport Block Size

TM: Transmission Mode

UCI: Uplink Control Information

USS: TIE-specific Search Space

Random Access Procedure

The random access procedure is generally performed in six steps.

(RA-0) A BS (e.g., eNB, gNB, network, or the like) broadcasts (or transmits) information about resources to be used for random access.

The BS broadcasts a configuration of DL resources and UL resources used for a UE (e.g., terminal or the like) to the UE by system information (e.g., see step S02 of FIG. 6 or step S12 of FIG. 7) during initial network access. After acquiring DL synchronization, the UE checks a random access-related configuration in the broadcast information from the BS and attempts to access by transmitting Msg1 (e.g., see step S03 of FIG. 6 or step S13 of FIG. 7). Msg1 may also be referred to as a random access preamble, an RACH preamble, or a PRACH preamble.

In the MTC and NB-IoT systems, a different available Msg1 time/frequency/sequence may be defined for the UE according to the CE level of the UE. Besides, resources available in steps (RA-1), (RA-2), (RA-3), and (RA-4) may be configured differently for each CE level. The CE level is determined according to a RSRP threshold broadcast in system information by the BS, and the UE selects a CE level by comparing an RSRP value measured in DL by the UE with the RSRP threshold broadcast by the BS. In MTC, CE modes are additionally defined, including CE Mode A and CE Mode B (e.g., see Table 7 and the related description). Once the UE enters the RRC_CONNECTED state, the BS may configure a CE mode. However, the UE operates on the assumption of CE Mode A for CE levels 0 and 1 and CE Mode B for CE levels 2 and 3 in the initial random access procedure.

(RA-1) The UE transmits Msg1 to the BS.

The UE first determines its CE level and transmits the preamble (Msg1) (e.g., the random access preamble, the RACH preamble, or the PRACH preamble) in Msg1 resources configured for the CE level (e.g., see step S03 of FIG. 6 or step S13 of FIG. 7). An RA-RNTI value is defined according to the time/frequency resources in which Msg1 is transmitted, and the Msg1 preamble selected by the UE is used as a random access preamble identifier (RAP-ID).

(RA-2) The BS transmits a response to the detected Msg1 to the UE as Msg2.

Msg2 transmitted by the BS is referred to as a random access response (RAR), and the RAR is included in/transmitted through an (N)PDSCH. The (N)PDSCH is scheduled by an (N)PDCCH or an MPDCCH (e.g., see step S04 of FIG. 6 or step S14 of FIG. 7). Therefore, the UE monitors the (N)PDCCH or the MPDCCH after transmitting Msg1. Information required for attempting to detect the (N)PDCCH or the MPDCCH, such as information about time/frequency resources (e.g., an NB or an NB-IoT carrier), information about a maximum repetition number, and information about frequency hopping, etc., is obtained from the information broadcast in step (RA-0). Since the (N)PDCCH or the MPDCCH that the UE attempts to detect has been scrambled with the RA-RNTI value in step (RA-1), UEs which have transmitted Msg1 in the same time/frequency resources may detect the same (N)PDCCH or MPDCCH ((N)PDCCH or MPDCCH scrambled with the same RA-RNTI). When the UE successfully detects the (N)PDCCH or MPDCCH, the UE acquires RAR information by detecting an (N)PDSCH indicated by corresponding DCI. The RAR may include information about a plurality of Msg1 s which are detected by the BS in step (RA-1), and the plurality of Msg1 s are distinguished by RA-RNTIs. That is, the UE searches, in the (N)PDSCH, the RA-RNTI value corresponding to the Msg1 preamble that was used in step (RA-1), and acquires RAR information corresponding to the RA-RNTI. The RAR information includes a configuration for Msg3 to be transmitted in step (RA-3) by the UE and a TA value estimated in step (RA-1). The configuration for Msg3 transmitted in step (RA-3) may be a UL grant. In MTC, the RAR also includes information about the frequency resources (NB) of an MPDCCH to be monitored in step (RA-4).

(RA-3) The UE transmits Msg3 to the BS as indicated by Msg2.

The UE transmits an (N)PUSCH in Msg3 as indicated by the UL grant acquired in step (RA-2) (e.g., see step S05 of FIG. 6 or step S15 of FIG. 7). The UE may include its ID (e.g., an SAE temporary mobile subscriber identity (S-TMSI)) in Msg3, for contention resolution in step (RA-4).

(RA-4) The BS detects Msg3 and transmits Msg4 to the UE in response to Msg3.

The UE attempts to detect Msg4 in response to Msg3 transmitted in step (RA-3) (e.g., see step S06 of FIG. 6 or step S16 of FIG. 7). As in step (RA-2), the UE attempts to first detect an (N)PDCCH or an MPDCCH. An RNTI used for scrambling the (N)PDCCH or the MPDCCH may be a temporary cell RNTI (TC-RNTI) received in the RAR in step (RA-2). The detected (N)PDCCH or MPDCCH may include a UL grant indicating Msg3 retransmission or may be a DL grant that schedules an (N)PDSCH including a response to Msg3. That is, upon detection of the UL grant, the UE may perform step (RA-3) again as indicated by the UL grant, and upon detection of the DL grant, the UE may detect the (N)PDSCH as indicated by the DL grant and thus check the response to Msg3.

E.1 Measurement Report During Random Access Procedure

The UE may report information regarding DQI to the BS in step (RA-1) or step (RA-3) in the random access procedure, and differently depending on the reporting step. That is, the UE may transmit (or report) Msg1 (a preamble) and/or Msg3 including the information regarding DQI to the BS.

First, in the case of DQI reporting in step (RA-1), different Msg1 resources (time and/or frequency and/or preamble) available to the UE may be configured according to DQI in step (RA-0). That is, the resources of Msg1 transmitted by the UE may first be selected according to the CE level, and then resources of a level corresponding to the DQI among one or more levels subdivided according to DQIs from the corresponding resources may be configured. In other words, the resources of Msg 1 transmitted by the UE may be configured in 2 steps (according to a CE level in the first step and then according to DQI in the second step). The DQI included in Msg1 represents high or low relative to a specific value among various DQI levels proposed below, and an offset level of the DQI based on the corresponding value may be transmitted to the BS in Msg3 or in other resources at another time.

This is because the CE level selected by the UE is set only based on an RSRP, the CE level may represent only information about a signal strength. For example, it may occur that despite a high signal strength, a signal/channel quality may be low due to interference between adjacent cells and a high spatial correlation between multiple antennas of the BS. This means that even when the CE level is low (the RSRP is relatively high), the UE may have poor (N)PDCCH/MPDCCH or (N)PDSCH reception performance in step (RA-2) or step (RA-4). That is, since the reception performance of the UE is more closely related to the signal/channel quality than the signal strength, the resources of Msg1 may further be classified according to a DL channel within the same CE level, for the purpose of notifying the signal/channel quality to the BS in advance. The BS may efficiently perform DL scheduling by acquiring the channel quality information from the detected resources of Msg1.

In another method, the UE may provide DQI in step (RA-3) so that the BS may use the DQI for DL scheduling in step (RA-4). Other methods may be considered according to the type of a random access procedure.

The methods will be described below in greater detail.

E.1.1 Measurement Report During Contention-Based Random Access (CBRA) Procedure

As described above, the UE may report DQI in step (RA-3), and the DQI may be related to the reception performance of the (N)PDCCH/MPDCCH and/or the reception performance of the (N)PDSCH in step (RA-4).

That is, the reported DQI may include the following information. The following information is only classified for the convenience of description, and the DQI may include all or part of the following information.

(1) Reference Signal Received Quality (RSRQ)

An RSRQ is a value representing the channel quality of an actual DL RS, as a reference metric that may be directly or indirectly used for DL scheduling of a BS. Unlike a general CQI, an RSRQ does not require a configuration such as a specific reference MCS, PMI, or RI. Therefore, the RSRQ may be obtained with lower complexity than CQI estimation, and after receiving the DQI, the BS does not request a constraint related to a transmission mode (TM) to be used for DL scheduling to the UE. The RSRQ may be used as a more suitable DQI, particularly in a situation in which the reference MCS and PMI are not configured in the random access procedure.

A. RSRQ value of (NB-IoT) carrier or narrowband (NB) in which Msg2 has been received.

A one-level difference between reported logical values may be a value obtained by dividing an RSRQ range unequally.

i. Average RSRQ of hopped frequency, when Msg2 hops in frequency (e.g. NB).

ii. Or an RSRQ value measured in specific frequency resources (center 6 RBs carrying a PSS/SSS, a frequency resource with the lowest/highest of the indexes of frequency hopping resources, or a value indicated in step (RA-0)).

The frequency resources may also be applied when the DQI includes not an RSRQ bus information about the reception performance of a specific channel (e.g., the (N)PDCCH/MPDCCH or the (N)PDSCH) (e.g., a condition for satisfying a specific block error rate (BLER), such as a repetition number or an aggregation level (AL)).

iii. Or information about a frequency resource with the highest RSRQ or the RSRQ of each frequency resource

iv. Or the RSRQ of frequency resources to be used for (N)PDCCH/MPDCCH monitoring in step (RA-4)

v. Or the RSRQ of frequency resources to be used for (N)PDSCH reception in step (RA-4)

vi. Or the RSRQ of a frequency resource overlapped between frequency resources used for (N)PDCCH/MPDCCH monitoring and frequency resources used for Msg2 reception in step (RA-4)

vii. Or the RSRQ of a frequency resource overlapped between frequency resources used for (N)PDSCH reception in step (RA-4) and frequency resources used for Msg2 reception

viii. The RSRQ of each frequency resource (e.g., NB) is derived from an RSRP and a received signal strength indicator (RSSI). The RSSI may be the average of the RSSIs of specific frequency resources or acquired frequency resources, and the RSRP may be the RSRP of each frequency resource. On the contrary, on the assumption that RSSI information including noise and interference may be different for each frequency resource, the RSSI may be the RSSI of each frequency resource.

(2) Information about (N)PDCCH, MPDCCH, or (N)PDSCH Reception in Msg2

A. The repetition number R and/or AL of the (N)PDCCH/MPDCCH or the (N)PDSCH when the (N)PDCCH/MPDCCH or the (N)PDSCH has been successfully received.

A maximum repetition number Rmax of the (N)PDCCH/MPDCCH or the (N)PDSCH is obtained in step (RA-0), and the UE may successfully detect the (N)PDCCH/MPDCCH or the (N)PDSCH with a repetition number R less than the maximum repetition number Rmax. Therefore, the repetition number R may be used to represent the DQI of the UE. When aggregation is applied (to the (N)PDCCH/MPDCCH), information about an AL at which the (N)PDCCH/MPDCCH has been successfully received and detected may also be used. According to the number of bits used for a quality report (e.g., the repetition number R and/or the AL) in Msg3, a reporting range and/or the representation unit of the reported repetition number R and/or AL may be configured differently.

i. The lower bound of the representation range may be set to a specific value X, not 1. This is because a value lower than X means that the channel quality is already sufficiently good, and thus more detailed information may not be required. In other words, when the actual R value is less than X, a logical value mapped to the lower bound (or a minimum value except for a value reserved to maintain backward compatibility with the legacy system) may be reported.

ii. The upper bound of the representation range may be limited to aR (an actual repetition number that the BS has used for the (N)PDCCH/MPDCCH or (N)PDSCH transmission, which may be less than or equal to Rmax and indicated by DCI). Alternatively, the upper bound of the representation range may be limited to Rmax or a value that is K times (e.g., twice) larger than Rmax. The reason for allowing a value greater than Rmax is that a repetition number available for scheduling of the (N)PDCCH/MPDCCH or (N)PDSCH in Msg4 (e.g., the maximum repetition number Rmax) may be different from a repetition number for Msg2.

iii. Representation units may not be uniformly set within the allowed representation range. That is, the unit/interval of R and/or an AL represented by one unit in a low range of reported logical values may be different from the unit/interval of R and/or an AL represented by one unit in a high range of reported logical values. This is because an inaccurate value (quantization error) at a low R value and/or AL has no significant effect on scheduling in step RA-4, but a one-step difference at a high R value and/or AL may lead to a very different repetition number applied to actual DL scheduling in step (RA-4).

The above proposed DQI representation may be applied to and cover all of the cases proposed below in which an R value or an AL is included in the DQI. Further, when an R value or an AL is selectively included in the DQI, it is necessary to define a reference AL and a reference R value to obtain an R value and an AL, respectively. That is, there may be a need for a reference AL that the UE may assume in deriving an R value satisfying a specific performance requirement for the (N)PDCCH/MPDCCH. Likewise, in the case of deriving an AL, a reference R value that may be assumed by the UE may be required. Each of the reference AL and R values may be derived from the maximum repetition number Rmax of the Msg2 MPDCCH, configured independently by the BS, or derived from the AL and/and R values actually applied to the Msg2 MPDCCH transmission. For example, the DQI may selectively include an AL. In a more specific example, when the R value satisfies a specific performance requirement, the DQI may include the AL together with the R value. In another example, when R is a value (e.g., 1) that satisfies a specific performance requirement, the DQI information includes the R value without the AL, and the reference AL (e.g., 24) may be assumed as the AL. In this example, when the repetition number R of the (N)PDCCH/MPDCCH or (N)PDSCH at the time of successful reception of the (N)PDCCH/MPDCCH or (N)PDSCH satisfies a specific performance requirement (e.g., 1), the reference AL may be derived from R (e.g., 1).

The DQI is reported as the repetition number R and/or AL of the (N)PDCCH/MPDCCH or (N)PDSCH which the UE has successfully received in Msg2, because the value of R is too small to calculate a CQI on the assumption of an RSRQ and a channel in a specific format (e.g., (N)PDCCH, MPDCCH, or PDSCH), and thus an RS should be received for an additional time to measure an RSRQ or a CQI. That is, when the UE has succeeded in receiving and detecting Msg2 in time resources less than a specific value (configured by the BS or defined in the standard), reporting indirectly to the BS that the DL channel quality is sufficiently good rather than measuring an RSRQ or a CQI may be profitable in terms of power saving. To this end, the BS may reserve specific DQI value(s) to be received for such a report. That is, when the R value and/or the AL is sufficiently small, the UE may selectively report an R value and/or an AL from among the reserved states. When the reserved states are not defined separately, a specific DQI value (a value indicating a good channel quality) may be reported.

(3) Information about Reception Performance of (N)PDCCH/MPDCCH in Msg4

A. The UE may acquire frequency resources (e.g., an (NB-IoT) carrier or NB) available or likely to be used in step (RA-0) and/or step (RA-4). After all, since the first step in which the DQI transmitted in Msg3 may be used is to schedule the (N)PDCCH/MPDCCH for step (RA-4), the DQI of the frequency resources that may be used in step (RA-4) may be preferably reported. However, accurate information about frequency resources to be used for MPDCCH monitoring in step (RA-4) may be indicated by the RAR of the Msg2 PDSCH in a system such as MTC, the remaining time until the Msg3 transmission after acquisition of the accurate information may not be sufficient for calculating the DQI of the frequency resources. Therefore, the following methods may be considered.

i. The DQI of each frequency resource likely to be used in step (RA-4) may be calculated based on the information acquired in step (RA-0), and only DQI corresponding to the information acquired from the RAR (e.g., a frequency resource to be monitored in step (RA-4)) may be reported.

ii. If frequency hopping is applied, frequency resources that have been used for hopping before a time X from the Msg3 transmission may be excluded from DQI measurement and reporting. Alternatively, when X is less than a specific value, DQI reporting may be skipped, or the maximum of reportable DQI values may be limited to a specific value according to X.

iii. Msg2 includes the (N)PDCCH/MPDCCH and the (N)PDSCH. DQI reference resources used for DQI measurement may be limited to the (N)PDCCH/MPDCCH, and further to resources within a time Y at the start of the (N)PDCCH/MPDCCH transmission (or at the start of a configured Msg2 monitoring period). This may be done to lower the processing power of the UE as much as possible. Alternatively, if the processing power of the UE is sufficient, even though the UE has succeeded in detecting the (N)PDCCH/MPDCCH before Rmax, the UE may be configured to additionally receive a longer period/more resources (less than Rmax) and measure DQI. Further, a time/frequency in which the (N)PDSCH is received may also be included in the DQI reference resources (a hypothetical resource that may be used for DQI measurement or transmission of a channel related to the DQI). Particularly in a situation where although the Msg2 (N)PDCCH/MPDCCH frequency resources are not fully included in the Msg4 (N)PDCCH/MPDCCH frequency resources, the (N)PDSCH frequency resources may be partially included in the Msg4 (N)PDCCH/MPDCCH resources, the need for the DQI reference resource extension (to include even the (N)PDSCH resources) may be pressing.

B. As in the above proposal, channel quality information measured in multiple frequency resources may be reported in the following methods.

i. The channel quality information may all be reported on a frequency resource basis.

ii. Alternatively, the average or representative value of the measured values of the respective frequency resources may be reported as the channel quality information. (An RSSI may be an average value, whereas an RSRP may be measured independently on an NB basis. When an RSRQ or reception performance-related information is reported, noise information may be calculated based on the average value, and quality information may be calculated based on the value measured on an NB basis.)

iii. Or DQI differences (e.g., expressed as delta values or offsets from the average or representative value) together with the average or representative value of the measured values of the respective frequency resources may be reported for the remaining or all frequency resources.

iv. Or DQI difference of a specific frequency resource (e.g., expressed as a delta value or offset from the average or representative value) among DQI reference resources, together with the average or representative value of the measured values of the respective frequency resources may be reported for the remaining or all frequency resources.

v. Or only DQI corresponding to the information acquired from the RAR (frequency resources to be monitored in step (RA-4) or a specific frequency resource indicated for reporting by the standard or system information (e.g., an anchor carrier, center 6 RBs carrying a PSS/SSS, frequency resources used for Msg2, or a frequency resource closest to the frequency resources used for Msg2 among frequency resources to be used for Msg4) may be reported.

vi. Or the average value of the measured values of the respective frequency resources may be reported.

vii. Or among the measured values of the respective frequency resources, the channel qualities and indexes of the best N frequency resources may be reported (N may be configured by system information or indicated by Msg2).

viii. Or among the measured values of the respective frequency resources, the channel qualities and indexes of the poorest N frequency resources may be reported (N may be configured by system information or indicated by Msg2).

C. Based on the information acquired before step (RA-3) process, the following may be performed.

i. The channel quality information measured as in the above proposal may include a (UE-preferred) minimum R value and/or a minimum AL from which a BLER of Z % (e.g., 1%) may be expected with respect to a specific reference DCI format (e.g., the DCI format of the (N)PDCCH/MPDCCCH expected in Msg4) and/or port information about an RS (e.g., DMRS) and/or a resource allocation type (e.g., distributed or localized) and/or an (N)CCE/ECCE index. For the reference DCI format, assumption of a specific DMRS port may be allowed.

ii. When the (UE-preferred) R value of the Msg4 (N)PDCCH/MPDCCH in step (RA-4) is reported, R may be represented as information about a ratio to Rmax to be used in step (RA-4), which has been obtained before step (RA-3). That is, in regards to the logical value range of reported DQI, an actual R value may be interpreted differently according to Rmax to be used in step (RA-4), which has been obtained in step (RA-3). In the above proposal, the units of the logical values may not be uniformly distributed in an actual representation range of R.

Similarly to the description in (2), when a repetition number R or an AL is selectively included in DQI, it is necessary to define a reference AL and a reference R value in obtaining the R value and the AL, respectively. That is, a reference AL value that may be assumed by the UE may be required in deriving an R value that satisfies a specific performance requirement for the (N)PDCCH/MPDCCH. Likewise, a reference R value that may be assumed by the UE may be required in deriving an AL. Each of the reference AL and R values may be derived from Rmax of the Msg2 MPDCCH, configured independently by the BS, or derived from an AL and/or an R value actually applied to the Msg2 MPDCCH transmission. For example, the DQI may selectively include an AL. In a more specific example, when R is a value (e.g., 1) that satisfies a specific performance requirement, the DQI may include an AL together with an R value. In another example, when R is a value (e.g., 1) that satisfies a specific performance requirement, the DQI may include an R value without an AL, and the reference AL (e.g., 24) may be assumed as the AL. In this example, if R of the (N)PDCCH/MPDCCH or the (N)PDSCH at the time of successfully receiving the (N)PDCCH/MPDCCH or the (N)PDSCH at the UE is a value (e.g., 1) satisfying a specific performance requirement, the reference AL may be derived from the R value (e.g., 1).

(4) Information about Reception Performance of N(PDSCH) in Msg4

A. In step (RA-0), the UE may acquire frequency resources (e.g., an (NB-IoT) carrier or NB) available or likely to be used in step (RA-4). In MTC, a frequency resource, NB in which the Msg4 PDSCH may be scheduled within the LTE system bandwidth is indicated by the Msg4 MPDCCH. In both NB-IoT and MTC, because (N)PDSCH scheduling information (e.g., an MCS, a TBS, resource allocation, and a repetition number) is indicated by a DL grant, the DQI transmitted in Msg3 may also be used in the Msg4 (N)PDSCH scheduling. Accordingly, the DQI transmitted in Msg3 may include the following information.

i. The DQI of each frequency resource likely to be used in step (RA-4) may be calculated based on the information acquired in step (RA-0), and when additional information (e.g., a frequency resource to be monitored in step (RA-4)) is acquired from the RAR, only the DQI of the frequency resource may be reported.

ii. If frequency hopping is applied, frequency resources that have been used for hopping before a time X from the Msg3 transmission may be excluded from DQI measurement and reporting. Alternatively, when X is less than a specific value, DQI reporting may be skipped, or the maximum of reportable DQI values may be limited to a specific value according to X.

iii. Msg2 includes the (N)PDCCH/MPDCCH and the (N)PDSCH. DQI reference resources used for DQI measurement may be limited to the (N)PDCCH/MPDCCH, and further to resources within a time Y at the start of the (N)PDCCH/MPDCCH transmission (or at the start of a configured Msg2 monitoring period). This may be done to lower the processing power of the UE as much as possible. Alternatively, if the processing power of the UE is sufficient, even though the UE has succeeded in detecting the (N)PDCCH/MPDCCH before Rmax, the UE may be configured to additionally receive a longer period/more resources (less than Rmax) and measure DQI. Further, a time/frequency in which the (N)PDSCH is received may also be included in the DQI reference resources. Particularly when the Msg2 (N)PDCCH/MPDCCH frequency resources do not hop or only frequency resources less than a specific ratio to the LTE system bandwidth are used, the need for the DQI reference resource extension (to include even the (N)PDSCH resources) may be pressing.

B. As in the above proposal, channel quality information measured in multiple frequency resources may be reported in the following methods.

i. The channel quality information may all be reported on a frequency resource basis.

ii. Alternatively, the average or representative value of the measured values of the respective frequency resources may be reported as the channel quality information. (An RSSI may be an average value, whereas an RSRP may be measured independently on an NB basis. When an RSRQ or reception performance-related information is reported, noise information may be calculated based on the average value, and quality information may be calculated based on the value measured on an NB basis.)

iii. Or DQI differences (e.g., expressed as delta values or offsets from the average or representative value) together with the average or representative value of the measured values of the respective frequency resources may be reported for the remaining or all frequency resources.

iv. Or only DQI corresponding to the information acquired from the RAR (frequency resources to be monitored in step (RA-4) or a specific frequency resource indicated for reporting by the standard or system information (e.g., an anchor carrier, center 6 RBs carrying a PSS/SSS, frequency resources used for Msg2, or a frequency resource closest to the frequency resources used for Msg2 among frequency resources to be used for Msg4) may be reported.

v. Or the average value of the measured values of the respective frequency resources may be reported.

vi. Or among the measured values of the respective frequency resources, the channel qualities and indexes of the best N frequency resources may be reported (N may be configured by system information or indicated by Msg2).

vii. Or among the measured values of the respective frequency resources, the channel qualities and indexes of the poorest N frequency resources may be reported (N may be configured by system information or indicated by Msg2).

C. Based on the information acquired before step (RA-3), the following may be performed.

i. The channel quality information measured as in the above proposal may include a minimum repetition number R (UE-preferred) and/or a minimum AL and/or RS (e.g., CRS or DMRS) port information and/or a resource allocation type (e.g., distributed or localized) and/or a PMI and/or frequency resource information (e.g., an NB or RB index requiring the smallest amount of resources (i.e., a small repetition number R and/or a low AL), from which a BLER of Z % (e.g., 1%) may be expected with respect to a specific reference format (e.g., a TBS and/or an MSC and/or a repetition number and/or a DMRS port of the (N)PDCCH/MPDCCCH expected in Msg4, which may be predefined in the standard or configured by system information or Msg2). When the specific reference format is not designated or information corresponding to a CQI, such as an MCS is not specified for the reference format, a CQI and/or an RI may be included in the DQI.

1. When a CQI is estimated based on channel information estimated from the CRS, precoding information (e.g., the correlation between the CRS and the DMRS, such as DMRS port information or a PMI) that the UE will assume may be given in advance.

ii. When the (UE-preferred) R value of the Msg4 (N)PDCCH/MPDCCH of step (RA-4) is reported, R may be represented as information about a ratio to the maximum repetition number Rmax to be used in step (RA-4), which has been obtained before step (RA-3). That is, in regards to the logical value range of reported DQI, an actual R value may be interpreted differently according to Rmax to be used in step (RA-4), which has been obtained in step (RA-3). In the above proposal, the units of the logical values may not be uniformly distributed in an actual representation range of R.

D. In the above proposal, when the DQI includes information related to (N)PDSCH reception performance, the UE may estimate the DQI, assuming a specific TM. For example, the UE may always assume a fallback TM (e.g., TM1 or TM2) as the TM used in the random access procedure or may derive a fallback TM or a reference TM according to the number of transmission (Tx) antennas (e.g., the number of CRS antenna ports) of the BS. Then, the UE may measure the DQI based on the TM. Further, the BS may directly indicate a reference TM available for DQI measurement.

In the above proposal, when the UE fails in receiving the response (Msg4) to Msg3 or retransmits Msg3, the DQI may be treated as follows.

(1) When Msg3 is retransmitted, the following operations may be performed.

A. When the DQI is channel-encoded together with data of Msg3 in the physical layer, the DQI used in the previous transmission is continuously transmitted.

B. When the DQI is channel-encoded (e.g., in the form of UCI) independently of the data of Msg3 in the physical layer, the DQI used in the previous transmission may be maintained or updated. When the DQI is updated, reporting of a value equal to or less than the previous reported DQI may not be allowed (e.g., when a DL channel state is better with a lower DQI).

(2) When retransmission starts from Msg1, the following operations may be performed

A. When the time resources (the maximum repetition number Rmax for Msg2 or Msg4) and/or frequency resources (e.g., (NB-IoT) carrier or NB) of Msg2 and/or Msg4 associated with Msg1 used in the retransmission are changed, DQI may be newly measured.

B. Otherwise, reporting of a value equal to or less than the previous reported DQI may not be allowed. Further, reporting of a value equal to or larger than the previous reported DQI without DQI re-measurement may be allowed (e.g., when a DL channel state is poorer with a higher DQI).

In all of the above proposals, when a repetition number R and an AL are used as values representing DQI, the DQI may include the repetition number R and the AL, separately, in combination, or as modified in a similar concept of a code rate.

In the proposals, the MPDCCHs transmitted in Msg2 and Msg4 are transmitted through DMRS ports, not CRS ports in MTC. In this case, the UE has difficulty in predicting MPDCCH performance using the CRS. That is, it may be difficult to derive, from the CRS, a specific condition that an MPDCCH decoding failure probability is equal to or less than a specific value. Then, a reference channel from which performance is derived may be defined as a channel other than the MPDCCH, while DQI measurement based on the CRS is allowed. For example, a reference channel used for RLM (e.g., a PDCCH format based on which out-of-sync is checked or a PDCCH format based on which in-sync is checked), a third PDCCH format, or a PDSCH format based on the assumption of a specific TM may be defined, and information based on the CRS, from which reception performance may be predicted based on the above-enumerated channel may be defined as DQI. The TM may be given as TM1 or TM2 according to the number of CRS ports.

E.1.2 Measurement Report During Contention-Free Random Access (CFRA) Procedure

To report DQI in a CFRA procedure, all of the methods proposed in section E.1.1 (‘Measurement Report During Contention-Based Random Access (CBRA) Procedure’) may be applied. CFRA is for a case in which a BS has allocated resources of Msg1 (e.g., time and/or frequency and/or preamble resources for Msg1) UE-specifically to a UE. For example, CFRA takes place mainly for updating TA information about a UE in the RRC_CONNECTED state. That is, when DL scheduling is required for the UE in a situation the BS has not received a UL transmission from the UE for a specific time or longer or has not performed UL scheduling, CFRA may be used to update a UL TA and thus reduce performance degradation caused by timing misalignment in reception of a feedback (e.g., ACK/NACK) and/or CSI for a later-scheduled DL transmission on a PUCCH and/or an (N)PUSCH. This means that the BS plans to perform DL scheduling for the UE after the CFRA procedure, and reception of DQI in Msg3 even in the CFRA procedure at the BS may help to minimize the performance degradation of later DL scheduling.

However, the CFRA procedure may be different from the CBRA procedure in that DQI reference resources may be added or redefined because the UE has already registered to the cell and acquired UE-dedicated information additionally by an RRC message. For example, the BS may additionally configure reference resources (e.g., different from DQI reference resources used in CBRA) in which the UE will measure DQI to be reported, for the UE in the random access procedure. The DQI reference resources may be configured by RRC signaling or DCI triggering Msg1. Alternatively, specific resources of DQI reference resource set configured by RRC signaling may be indicated as the DQI reference resources by DCI. In this case, the DQI may be reported in Msg3 (or the first (N)PUSCH transmitted after Msg2) in the form of UCI, not a MAC message.

When the DQI includes information related to (N)PDSCH reception performance, the UE may estimate the DQI by assuming a specific TM. For example, the UE may always assume a fallback TM (e.g., TM1 or TM2) as the TM for the random access procedure or derive a fallback TM or a reference TM according to the number of Tx antennas (for example, the number of CRS antenna ports) of the BS, to measure the DQI based on the TM. Further, the BS may directly indicate a reference TM available for DQI measurement to the UE, or the UE may measure the DQI by assuming a TM used in the RRC_CONNECTED state.

The reference TM referred to in the process of deriving DQI in the CBRA and CFRA procedures may be specifically defined according to the number of CRS ports of the BS as follows.
If the number of CRS ports is one, TM1 is assumed as the reference TM.
Otherwise, TM2 is assumed as the reference TM.

E.2 Measurement Report for UL Semi-Persistent Scheduling (SPS)

The BS may configure UL SPS to reduce resources required for UL scheduling of the UE. Because a UL grant for UL scheduling is not transmitted each time, UL SPS may also be effective in reducing power that the UE uses for DL monitoring. UL SPS is a technique of preconfiguring multiple time-domain UL resources for a UE so that the UE may transmit data in the UL SPS resources by its own decision without dynamic UL scheduling of a BS. UL SPS may be similar to SPS already defined in the legacy LTE system or other systems, and independent of the RRC states. That is, in the present proposal, UL SPS refers to a communication procedure and method in which a UE is allowed to perform a UL transmission without the need for UL scheduling of a BS each time.

However, when UL SPS activation/deactivation is supported by DCI or when there may be an HARQ feedback for UL SPS, the UE still needs to receive a DL signal or channel (e.g., (N)PDCCH, MPDCCH, (N)PDSCH, wake-up signal (WUS), or the like). As such, the BS may need to transmit a specific channel to the UE even in the UL SPS situation. For link adaptation, all of the methods proposed in section E.1.1 (‘Measurement Report during Contention-Based Random Access (CBRA) Procedure’) and section E.1.2 (‘Measurement Report during Contention-Free Random Access (CFRA) Procedure’) may be used.

However, because UL SPS time/frequency resources may be different from time/frequency resources to be used for Msg2 and/or Msg4 in the general random access procedure (e.g., DL resources to be used for a DL feedback for a UL SPS reception at the BS (i.e., DL resources to be monitored by the UE) may be independent of Msg2/Msg4 of the random access procedure), DQI reference resources for UL SPS may be configured independently. The DQI reference resources for UL SPS may be directly defined in the standard, configured by system information or an RRC message, directly indicated by a channel (e.g., DCI) for activating/deactivating UL SPS, or a channel for HARQ feedback (e.g., (N)PDCCH or MPDCCH).

Further, DQI reported in the UL SPS procedure may differ from DQI reported in the random access procedure, in terms of definition or a representation range. The DL channel (e.g., specific DCI) used for UL SPS activation/deactivation and/or HARQ feedback may be different from a DL channel (e.g., DCI with a type-2 common search space (CSS)) carrying Msg2 and/or Msg4 in the random access procedure. Herein, DQI may be measured with a DL channel defined for UL SPS as a reference (or reference channel), and then reported.

E.3 Measurement Report According to Receiver Type of UE

When the UE reports DQI during random access, a channel quality may be differently defined according to the receiver type of the UE. The receiver type of the UE may be one of receiver types defined to satisfy a specific performance requirement in the standard. In LTE, for example, the receiver types may include maximal ratio combining (MRC), minimum mean square error-interference rejection and combining (MMSE-IRC), enhanced MMSE-IRC (eMMSE-IRC), maximum likelihood (ML), and successive interference cancellation (SIC). The BS needs to know these receiver types to avoid unnecessary resource waste by predicting the reception performance of the UE in advance during DL scheduling of the BS. Further, the BS needs to know these receiver types because it needs to provide additional information to the UE according to the receiver type of the UE in some cases.

(1) When the UE uses multiple Rx antennas, the UE may report DQI in consideration of the multiple Rx antennas. Information about the multiple Rx antennas of the UE (e.g., information indicating whether an actual number of Rx antennas is indicated or a single reception antenna is assumed) together with the DQI may be included in a measurement report.

(2) The DQI reported by the UE may be derived based on the assumption of a single Rx antenna. When an additional Rx antenna is available for the UE (i.e., multiple Rx antennas), it may be additionally reported. For example, the Rx antenna information may be a representation of an additional gain (e.g., an RSRQ gain, an SNR gain, or reduction of a repetition number expected to receive Msg2 and Msg4 under a specific detection performance requirement (e.g., BLER)) which may be obtained when the multiple Rx antennas are used, or an indication simply indicating that the multiple Rx antennas may be used in Msg2 and/or Msg4.

E.4 Conditions for not Expecting DL Channel Quality Measurement

The proposed DQI measurement information may be used for DL scheduling and resource allocation (a code rate, a repetition number, and so on) of the BS. Although an additional operation is required for DQI measurement of a low-cost UE, the DQI measurement information may advantageously prevent the loss of power saving, caused by wrong link adaptation of the BS and hence DL reception signal detection failure (e.g., due to too small a repetition number) of the UE. However, when the maximum repetition number of Msg4 is initially smaller than a specific value, link adaptation may not be important, and thus DQI measurement may be skipped to save power of the UE. On the contrary, when the maximum repetition number of Msg4 is set to be larger than the specific value or the RSRP or SNR of the UE is very low (e.g., when the UE has a high CE level or the highest of CE levels configured in the cell), the accuracy of the DQI measurement information of the UE may be very low. Accordingly, there may be a certain condition for not measuring or reporting DQI to prevent unnecessary or meaningless power consumption of the UE, as follows.

(1) The maximum repetition number of the (N)PDCCH/MPDCCH or (N)PDSCH of Msg4 is less than a specific value.

(2) The maximum repetition number of the (N)PDCCH/MPDCCH or (N)PDSCH of Msg4 is larger than a specific value.

(3) The UE successfully receives Msg2 ((N)PDCCH/MPDCCH or (N)PDSCH) with a specific number of or fewer repetitions.

In the above conditions, each specific value may be defined in the standard or may be information broadcast by the BS.

Alternatively, when an Msg3 transmission time indicated by Msg2 is not sufficient for DQI measurement, the UE may be allowed to skip DQI measurement and reporting or to report a specific value (e.g., a value indicating a poorest DL channel quality) as DQI. Herein, the “time that is not sufficient for DQI measurement” may be a relative time interval between Msg2 and Msg3, and may be defined as a UE capability.

E.5 DL Channel Quality and Method of Reporting the DL Channel Quality, when Random Access is Used for Special Purpose

When the UE attempts the random access procedure for mobile oriented early data transmission (MO-EDT) (for transmitting UL data during the random access procedure), an information size required for DQI reporting may not be considered in selecting a TBS for Msg3 transmission. When the smallest of TBSs allowed for the UE to use for Msg3 (TBSs larger than the size of data/information that the UE wants to transmit in Msg3) is large enough to cover a size required to report DQI, except for the size of the data/information that the UE actually wants to transmit in Msg3, the UE may additionally include and transmit the DQI in Msg3.

When the BS performs mobile terminated early data transmission (MT-EDT for transmitting DL data during the random access procedure) after the UE starts the random access procedure, the UE may be requested to report DQI on UL even after Msg3 and/or Msg4. This is because in the case of EDT, the UE may complete data transmission/reception with the BS in the RRC_IDLE state without entering the RRC_CONNECTED state and thus may not acquire detailed information for DL measurement as freely as in the RRC_CONNECTED state. That is, the UE may measure and report only DQI at a level allowed for random access, from the viewpoint of DQI measurement. However, it may be configured that DQI to be reported after Msg4 is measured in resources different from DQI reference resources used for DQI reporting in Msg3 in the proposed general random access procedure.

E.6 Reference Resources for DL Channel Quality Information

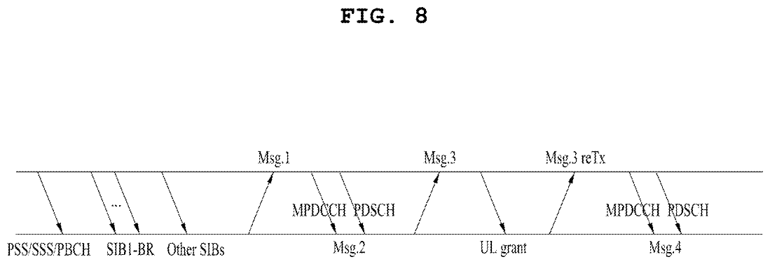

FIG. 8 illustrates a time flow of transmissions and receptions of channels and signals until Msg4 reception at the UE in the random access procedure, and the resource relationship of the channels/signals will be described in terms of frequency. FIG. 8 is based on eMTC, and may correspond to the example of FIG. 6. In FIG. 8, a UL grant that the UE receives after Msg3 transmission is scheduling information for Msg3 retransmission, using the same format as the Msg3/4 MPDCCH. In NB-IoT, the NPSS/NSSS/NPBCH is transmitted on an anchor carrier, and SIBs may be transmitted on the anchor carrier in FDD and on an anchor carrier or a non-anchor carrier according to NPBCH information in TDD (e.g., see FIG. 7 and the related description). The Msg2 NPDCCH and NPDSCH, the Msg3/4 NPDSCH, and the Msg4 NPDSCH are all transmitted on the same NB-IoT carrier, which may be an anchor carrier or a non-anchor carrier. In MTC, the DL resource relationship in the frequency domain is more complex, and may be summarized as follows.
PSS/SSS/PBCH
Center 6 RBs of LTE system bandwidth
SIB1-BR
SIB1-BR is transmitted in RBs distributed across the LTE system bandwidth, and the position of a used NB/RB may be different depending on the DL bandwidth and the cell ID.
Other SIBs
The position of an NB/RB is determined according to scheduling information for the SI of SIB1-BR.
MPDCCH of Msg2
It is determined according to information configured in an SIB and a preamble index used for Msg1 transmission, and frequency hopping may be applied according to rar-HoppingConfig.
PDSCH of Msg2
It is indicated by the MPDCCH of Msg2, and frequency hopping may be applied according to rar-HoppingConfig
MPDCCH of Msg3/4
It may be transmitted in an NB identical to the MPDCCH NB of Msg2 or an NB shifted from the MPDCCH NB of Msg2 by a specific offset value, and the offset value may be indicated by the UL grant of the RAR.
PDSCH of Msg4
It is indicated by the MPDCCH of Msg4 and frequency hopping may be applied according to rar-HoppingConfig.

As described above, the DL frequency resources used before Msg4 reception are defined in a complex relationship in the MTC system. In some cases, Msg4 DL frequency resources to which DQI may be applied first may be resources that the UE does not need to receive (according to the legacy random access procedure). That is, it may be determined whether the corresponding information may be effectively used for Msg4 scheduling according to how DQI reference resources are defined. In consideration of the above, this section proposes DQI-reference resources (DQI-RS). The proposed method may all be applied unless contradicting with other proposals described in the present disclosure.

The DQI-RS needs to be selected from among resources which may represent the channel quality of resources scheduled for transmission of the Msg3/4 MPDCCH and/or (N)PDSCH and which the UE may receive before transmitting Msg3. When Msg3/4 MPDCCH resources are the same as Msg2 reception resources, the DQI-RS may be defined as part or all of the Msg2 MPDCCH/NPDCCH resources. The following is a method of selecting a DQI-RS, when Msg2 MPDCCH/NPDCCH resources are expected to be different from Msg3/4 MPDCCH/NPDCCH and/or (N)PDSCH resources.
MTC
The center 6 RBs and/or an NB carrying system information and/or an NB carrying the Msg2 PDSCH may be additionally included in the DQI RS.
It may be determined whether an additional DQI RS is actually applied, according to whether frequency hopping is applied to the Msg2 MPDCCH and/or the Msg2 PDSCH.

According to the above method, the DQI RS is basically resources that an MTC UE may expect to receive before Msg3 transmission. When the DQI-RS is selected in this manner, the UE may not need to perform an additional reception operation for DQI measurement.
NB-IoT
RRC_IDLE state

(1) The BS may configure N (NB-IoT) carrier sets for the UE. The UE may randomly select a carrier from among the N carrier sets, measure the CQI of the carrier, and report the CQI. Alternatively, the UE may report the average and/or worst and/or best DQI of the N carrier sets.
The CQI may include information about a preferred carrier and/or repetition.
To avoid ambiguity about the CQI states of an existing early CQI report, the above method may be applied only to the DL CQI of a non-anchor carrier.
When the worst DQI and/or the best DQI is included, information about the carrier in which the DQI has been measured may be additionally reported, and directly included in the DQI value.

(2) Method of randomly selecting DQI reference carrier
The DQI reference carrier may be select based on a UE ID, the earliest receivable DQI-RS may be selected, or a carrier with a small/large Msg2 NPDCCH maximum repetition number may be selected first.
For two or more DQI-RS within a specific time, a DQI-RS carrier is selected based on the UE ID.

(3) When the UE acquires DQI for two or more DQI-RS carriers, the DQI-RS carriers may be prioritized as follows, for DQI reporting.
The best DQI, the DQI of a carrier that has been measured for the longest (i.e., a carrier expected to have the highest DQI measurement accuracy), or the DQI of the most recently updated carrier.

(4) When a CQI is selectively measured in a DL carrier or a set of DL carriers indicated by the BS, an NPRACH carrier is selected from among UL carriers associated with the corresponding DL carrier, and Msg1 is transmitted on the NPRACH carrier.
In general, a UL carrier is first selected for Msg1 and then DQI is measured in a DL carrier corresponding to the UL carrier in the random access procedure. In the above method, however, when it is determined to report the DQI of a specific DL carrier (e.g., a DL carrier corresponding to the best DQI) among multiple DL carriers, a UL carrier related to the DL carrier is selected.

(5) The BS may differentiate the configuration of a DQI-RS carrier set for each UL carrier for Msg1
RRC_CONNECTED state

(1) When the BS indicates NPDCCH order-based Msg1 transmission, the BS may directly indicate a DQI-RS carrier, and the UE may derive DQI from the DQI-RS carrier.

(2) After Msg3 transmission, the BS may change the DL carrier of the UE to the corresponding carrier.

(3) In the RRC connected mode, the UE may receive an indication indicating a DQI-RS carrier to be used for DQI measurement in the RRC_IDLE state from the BS.

E.7 Method of Indicating DL Quality Information Reporting

Considering a computation time for DQI estimation and a time taken for generating a signal/channel for reporting DQI in Msg3 at the UE, when the UE may obtain an indication of DQI reporting may be an important factor. Particularly when additional information is required for DQI measurement, the UE needs to obtain the information as soon as possible. This section proposes a method of indicating DQI reporting. The proposed method may all be applied unless contradicting with other proposals described in the present disclosure.
Method of using a bit/state of a UL grant included in an RAR
When the index of an Msg3/4 MPDCCH NB is a specific value, this is indirectly recognized as a DQI reporting indication. Characteristically, when a specific number or more Msg3/4 MPDCCH NBs are included in RAR monitoring NBs or when the interval between an RAR monitoring NB and an Msg3/4 MPDCCH NB is less than or equal to a specific value, it is determined that DQI reporting is indicated.
Method of using a reserved bit (s) of an RAR
In the case where (N)PRACH resources are used to request an EDT, when Msg2 indicates that the EDT request of the UE has been accepted by the BS, it is recognized as a DQI reporting indication.

Since the connected mode is generally not entered in EDT, an opportunity to receive DQI/CQI as soon as possible in this manner may be required.
If Msg2 is received for (N)PRACH resources which are not used for an EDT request, a specific reserved bit of the RAR may be interpreted as indicating DQI reporting.
Method of indicating the configuration of DQI to be reported by a UE
A CQI and a repetition number may be selectively indicated in DQI.

(1) In a specific CE mode, a CQI or a repetition number may be fixedly indicated. In a specific example, only the CQI may be reported in a CE mode that supports a relatively small repetition range or no repetition, or only the repetition number may be reported in a CE mode that supports a relatively large repetition range.
A DQI report mode may be indicated.

(1) DQI reporting may be indicated for a wideband and/or a preferred NB and/or an NB of a DQI RS closest to an Msg.3/4 MPDCCH NB and/or a specific NB of the DQI RS and/or an NB used for SIB reception and/or the center 6 RBs.

When it is necessary to divide the method of indicating DQI measurement and reporting into a step of configuring a measurement and a step of indicating reporting, this may be realized in the following manner.
A reserved bit of the RAR may be used to trigger DQI reporting, with the following features.
Whether the BS may receive/support a DQI report or a related configuration may be signaled (semi-)statically by high-layer signaling (e.g., system information or an RRC message), and on/off of DQI reporting may be indicated dynamically by a CSI report field in the UL grant of the RANR (in CE Mode A in eMTC) or the reserved bit of the RAR.
When the RAR is a response to an EDT request, a DQI report configuration indicated by high-layer signaling, not the reserved bit of the RAR may be followed (i.e., when DQI measurement and/or reporting is configured for the UE by higher-layer signaling, a decision as to whether to report DQI may not be based on an indication of a dynamic signal, which may be applied when the RAR does not have a reserved bit or the UL grant of the RAR does not have the CSI report field, as in eMTC CE Mode B).
When the CSI report field of the UL grant in the RAR is used as trigger information for DQI reporting, the reserved bit of the RAR may be used for the purpose of providing additional information related to a DQI report configuration (this is also similarly applicable to a reverse case in which usages of the CSI report field of the UL grant and the reserved bit of the RAR are switched).
This may be used to dynamically change a related configuration, when there are one or more DQI report configurations.
A DQI report configuration may include information indicating whether to report DQI, a DQI value range, the number of DQI bits, CSI resources (e.g., an NB set, a reference TM, and an NB-IoT DL carrier set), and a DQI report mode (e.g., a wideband or subband/NB (selected or preferred by the BS or the UE)).
Although the DQI report configuration may be determined by the CSI report field in the UL grant of the RAR and the reserved bit of the RAR, the DQI report configuration may be determined differently according to the TBS and/or duplex mode of Msg3, indicated by the UL grant of the RAR.
When the TBS of Msg3 is equal to (or smaller than) a specific value, DQI reporting may be disabled.
According to the TBS of Msg3 and/or the contents (e.g., RRC Resume, RRC Reconfiguration Request, or the like) of Msg3, a DQI report mode (e.g., a wideband or subband/NB (selected or preferred by the BS or the UE)), a DQI value range, and the number of DQI bits may be different.

E.8 Interpretation of Msg3/4 MPDCCH NB, when DL Quality Information Reporting is Indicated

As described above, the DQI may be used directly for the Msg3/4 MPDCCH. If the DQI-RS is different from the Msg3/4 MPDCCH (frequency) resources, the Msg3/4 MPDCCH resources may be derived based on a reported DQI-RS to more actively use the DQI. That is, when the BS has configured a set of Msg3/4 MPDCCH resources by system information, it is not easy to change the set of Msg3/4 MPDCCH resources. Therefore, when there is no misunderstanding about a DQI-RS between the BS and the UE, the UE may be allowed to interpret the Msg3/4 MPDCCH and/or PDSCH (frequency) resources differently from a value obtained from the system information according to the DQI-RS of the DQI reported by the UE. The proposed method may all be applied, unless contradicting with other proposals described in the present disclosure.
The Msg3/4 MPDCCH and/or PDSCH (frequency) resources may be interpreted as identical to or including some of Msg2 MPDCCH NBs (i.e., the Msg3/4 MPDCCH NB index indicated by the UL grant in the RAR is interpreted differently).
When DQI has been reported, a frequency hopping field may be included in the DCI of the Msg3/4 MPDCCH, or it may be allowed to use the frequency hopping field even in the Msg3/4 reception step.
When information about a preferred NB is included in the DQI, the UE may assume or receive an indication indicating that frequency hopping is off for the Msg3/4 MPDCCH and/or the Msg4 PDSCH.
Characteristically in CE Mode B, a frequency hopping on/off field may be added to the Msg4 DL grant or may be indirectly derived from a combination of other fields.
Characteristically in CE Mode B, the frequency hopping field in the Msg4 DL grant may be used to interpret whether a PDSCH scheduled by the DCI hops in frequency.

E.9 Configuration of DL Quality Information

The MTC UE and the NB-IoT UE support various CE levels and CE modes. The CE levels and CE modes reflect distances (i.e., SNRs) from the BS and mobility, and further, UE processing power. Accordingly, DQI which may be measured or generated by the UE needs to be limited in consideration of such various types of information about the surroundings. This section proposes the configuration and range of information included in DQI. The proposed method may all be applied, unless contradicting with other proposals described in the present disclosure.
Configuration of DQI report information

The DQI report information may include only part of the following DQI configuration information and may be reported to the BS.
Information indicating whether the DQI has been configured based on a CQI or a repetition number may be included.

(1) A DQI table may be made to include CQIs and repetition numbers, and a CQI or a repetition number may be reported according to an index selected in the DQI table by the UE. Characteristically, the lowest CQI in the DQI table may be configured to indicate a state similar to or better than a channel state indicated by the lowest repetition number in the DQI table (e.g., in terms of BLER).
Reporting types may include (a) wideband CQI or repetition, (b) wideband (CQI or repetition) and UE-selected (or BS-selected) NB index and CQI or repetition on the corresponding NB, (c) wideband (CQI or repetition) with PMI, and (d) wideband (CQI or repetition) without PMI.
The number of Rx antenna ports (characteristically, when the number of Rx antenna ports is larger than 1, the CQI (or repetition) is fixed to the highest value (or lowest value)).
The DQI information configuration may be configured differently depending on a CE level and/or whether an Msg2 MPDCCH repetition (e.g., an actual transmission number or a maximum repetition number) and Msg2 MPDCCH hopping are performed and/or depending on the PRACH format and whether PRACH repetition and PRACH hopping are performed.
When Msg1 has been transmitted in response to an EDT request or when the random access procedure is in progress as a part of the EDT process, it may be configured that a CQI is selected and reported.
Although the DQI UE may directly select a repetition number assumed for CQI measurement and indicate the repetition number together with a CQI in DQI to the BS, the repetition number may be configured directly by the BS or derived by a specific parameter. That is, the repetition number that the UE assumes for CQI measurement may be a specific predetermined value, not a value that may be directly selected by the UE. The value may be broadcast directly from the BS or defined by a relationship determined according to a CE level and a parameter of a channel to be monitored or used as a reference for CQI calculation by the UE.
DQI range
N sets of CQI (or repetition) value ranges are configured in an SIB, and a specific one of the N sets is indicated by the RAR.

(1) For each set, R_TM and/or R_DQI and/or R_CQI and/or R_Rep that the UE may assume in the DQI derivation process may be defined differently.
R_TM, R_DQI, R_CQI, and R_Rep represent a reference TM, a reference DQI-RS, a reference CQI, and a reference repetition number, respectively. Only when the UE has part of the information, the UE may estimate information suitable for DQI configuration information. Herein, a reference is a parameter that may be assumed to be used for hypothetical DL channel transmission in deriving the reception performance of a hypothetical DL channel that DQI is intended to represent.
A different DQI set may be available according to the number of Rx antenna ports. In this case, the UE needs to additionally notify the number of Rx antenna ports or information about a used set.
The DQI information configuration may be configured differently depending on a CE level and/or whether an Msg2 MPDCCH repetition (e.g., an actual transmission number or a maximum repetition number) and Msg2 MPDCCH hopping are performed and/or depending on the PRACH format and whether PRACH repetition and PRACH hopping are performed.

A corresponding specific value may be set as follows, when a different specific DQI reporting operation is performed according to whether the number of repetitions or subframes of an MPDCCH (or NPDCCH) and/or an (N)PDSCH received until the UE successfully demodulates/detects the MPDCCH (or NPDCCH) and/or (N)PDSCH of Msg2 is greater or less than a specific value (e.g., when the UE reports the repetition number of a hypothetical MPDCCH (or NPDCCH) and/or (N)PDSCH or a value corresponding to subframes or repetitions or an AL received until the UE successfully detects the MPDCCH (or NPDCCH) and/or (N)PDSCH).
The specific value may be set by the BS or predetermined to be a specific ratio of the maximum repetition number of a channel (e.g., MPDCCH (or NPDCCH) and/or (N)PDSCH) related to the RAR. (e.g., The predetermined value may be configurable by the BS or fixed in the standard, and the range/value of the ratio may also be different according to the maximum repetition number and/or frequency hopping or non-frequency hopping of the channel related to the RAR (e.g., MPDCCH (or NPDCCH) and/or (N)PDSCH).)
When the UE reports the value corresponding to the subframes or repetitions or AL received until successful MPDCCH (or NPDCCH) and/or (N) PDSCH detection as DQI, the corresponding value is specifically determined as follows.
When DQI is predefined/given as a plurality of repetition numbers, a DQI value is the smallest of values equal to or greater than an actual number of received subframes or repetitions among the predefined/given values.

E.10 DL Quality Information Report Mode

In this section, various modes for reporting DQI are proposed. As described above, the MTC and NB-IoT systems support various CE levels and CE modes, particularly, MTC has even the feature of frequency hopping of DL NB resources and thus there is a need for supporting a proper DQI report mode for each configuration in consideration of its features. The proposed method may be applied to all the other proposals, unless contradicting with the other proposals described in the present disclosure.
In CE Mode A, CQI-based DQI is reported.
If frequency hopping is enabled (rar-HoppingConfig is set), the following operations are performed.

(1) UE-selected subband feedback (aperiodic CSI report, Mode 2-0)
Legacy CSI reporting behavior
wideband CQI on all narrowband(s) in the CSI reference resource
preferred narrowband index within the set of narrowband(s) in which MPDCCH is monitored
CQI value reflecting transmission only over the preferred narrowband, CQI will be encoded differentially relative to wideband CQI
here CSI reference resource is:
In the time domain and for a BL/CE UE, the CSI reference resource is defined by a set of BL/CE downlink or special subframes where the last subframc is subframe n-n_{CQI_ref},
   where for periodic CSI reporting n_{CQI_ref} is ≥4:
   where for aperiodic CSI reporting n_{CQI_ref} is ≥4:
   where each subframe in the CSI reference resource is a valid downlink or valid special subframe:
   where for wideband CSI reports:
      The set of BL/CE downlink or special subframes is the set of the last ceil(R^{CSI}/N_{NB,hop}^{ch,DL}) subframes before n-n_{CQI ref} used for MPDCCH monitoring by the BL/CE UE in each of the narrowbands where the BL/CE UE monitors MPDCCH. where N_{NB,hop}^{ch,DL} is the number of narrowbands where the BL/CE UE monitors MPDCCH.
   where for subband CSI reports:
      The set of BL/CE downlink or special subframes is the set of the last R^{CSI} subframes used for MPDCCH monitoring by the BL/CE UE in the corresponding narrowband before n-n^{CQI_ref}:
   where R^{CSI} is given by the higher layer parameter csi-NumRepetitionCE.
In the frequency domain, the CSI reference resource includes all downlink physical resource blocks for any of the narrowband to which the derived CQI value relates
Proposed method
The UE follows a method similar to CSI report mode 2-0 for legacy BL/CE UEs, and the following modifications and additions are required.
R^{CSI}:R^{CSI} may be defined cell-commonly, R^{CSI} may be defined per each CE level, or R^{CSI} may be defined as a value dependent on an RAR MPDCCH repetition number (an actual MPDCCH repetition number or a maximum repetition number mpdcch-NumRepetition-RA). This value may be signaled by RRC signaling such as an SIB or by Msg2.
Preferred NB: An NB may be selected from among CSI reference resources in the frequency domain, which is closest to an NB used to monitor the Msg3/4 MPDCCH derived from an Msg3/4 MPDSCH NB index in the information received from the UL grant included in the RAR. The UE may calculate DQI (CSI) based on the CRS in only up to a specific step during MPDCCH monitoring for Msg2 reception, and completely calculate wideband CSI and the DQI (CQI) of the preferred NB after interpreting the RAR.
CSI reference resource: It may be replaced with the DQI-RS of the disclosure.

(2) Wideband CQI without PMI (periodic CSI report, mode 1-0)
Legacy CSI reporting behavior
One wideband CQI conditioned on transmission rank 1
Proposed method
The UE follows a method similar to CSI report mode 1-0 for legacy BL/CE UEs, and the following modifications and additions are required.
R^{CSI}:R_{CSI} may be defined cell-commonly, R^{CSI} may be defined per each CE level, or R^{CSI} may be defined as a value dependent on an RAR MPDCCH repetition number (an actual MPDCCH repetition number or a maximum repetition number mpdcch-NumRepetition-RA). This value may be signaled by RRC signaling such as an SIB or by Msg2.

(3) Wideband CQI with PMI (periodic CSI report, mode 1-1)
Legacy CSI reporting behavior
One wideband CQI and PMI within restricted subset of PMI if configured
Proposed method
The UE follows a method similar to CSI report mode 1-1 for legacy BL/CE UEs, and the following modifications and additions are required.
R^{CSI}: It may be defined cell-commonly, on a CE level basis, or as a value dependent on an RAR MPDCCH repetition number (an actual MPDCCH repetition number or a maximum repetition number mpdcch-NumRepetition-RA). This value may be signaled by RRC signaling such as an SIB or by Msg2.
R_TM: A reference TM may be defined. The reference TM may be signaled by RRC signaling such as an SIB or by Msg2 from the BS or determined according to the number of CRS ports of the BS. Further, the BS may indicate the reference TM to the UE in consideration of a PDSCH TM to be used after receiving Msg3.
PMI subset: It may be defined cell-commonly, on a CE level basis, or according to an RTM.
If frequency hopping is disabled, the following operations are performed.

(1) UE-selected subband feedback (aperiodic CSI report, mode 2-0)
Legacy CSI reporting behavior
Wideband CQI on all narrowband(s) in the CSI reference resource
Preferred narrowband index
Differential CQI value=0
Proposed method
The UE follows a method similar to CSI report mode 2-0 for legacy BL/CE UEs, and the following modifications and additions are required.
R^{CSI}: It may be defined cell-commonly, on a CE level basis, or as a value dependent on an RAR MPDCCH repetition number (an actual MPDCCH repetition number or a maximum repetition number mpdcch-NumRepetition-RA). This value may be signaled by RRC signaling such as an SIB or by Msg2.
CSI reference resource: Since an Msg3/4 MPDCCH NB may have different frequency-domain resources from the Msg2 MPDCCH, the UE may be configured to additionally use a channel to which frequency hopping is applied in the CSI reference resource. For example, there may be SIB1-BR and other SIBs.
Preferred NB: An NB may be selected from among CSI reference resources in the frequency domain, which is closest to an NB used to monitor the Msg3/4 MPDCCH derived from an Msg3/4 MPDSCH NB index in the information received from the UL grant included in the RAR. The UE may calculate DQI (CSI) based on the CRS in only up to a specific step during MPDCCH monitoring for Msg2 reception, and completely calculate wideband CSI and the DQI (CQI) of the preferred NB after interpreting the RAR.
In CE Mode B, DQI based on a required repetition number is reported.
If frequency hopping is enabled (rar-HoppingConfig is set), the following operations are performed.

(1) Operations in CE Mode B are the same as the aforementioned operations in CE Mode A, but repetition (or a repetition number) instead of a CQI is reported as DQI. In this case, DQI report may be measured/reported based on DQI instead of a CQI in the method described in relation to CE Mode A. For example, the DQI report may include only wideband DQI, or further include NB DQI measured in a preferred NB and information about the position of the preferred NB (e.g., preferred NB index) as well as the wideband DQI. In addition, for example, the wideband DQI and/or the NB DQI may be measured according to the method described in section G.1, and may include the information (the repetition number R and/or the AL) described in section G.1. In a more specific example, the wideband DQI and/or the NB DQI may include an RSRP/RSRQ value and/or reception information about the (N)PDCCH/MPDCCH or (N)PDSCH of Msg2 and/or information about the reception performance of the (N)PDCCH/MPDCCH of Msg4 and/or information about the reception performance of the (N)PDSCH of Msg4.

(2) R^{CQI}: A CQI value available as a reference needs to be defined. This value may be defined as a reference MCS used to report a repetition number satisfying a specific target reception performance (e.g., BER) by an MCS (a code rate, the number of layers, and a modulation order). The CQI value may be defined cell-commonly, on a CE level basis, or as a value dependent on an RAR MPDCCH repetition number (e.g., an actual MPDCCH repetition number or a maximum repetition number mpdcch-NumRepetition-RA). It may also be a value derived indirectly from the Msg2 MPDCCH. This CQI value may be signaled by RRC signaling such as an SIB or by Msg2. Alternatively, for example, the modulation order and TBS (or the number of bits derived from a corresponding fixed DCI format) of the Msg2 MPDCCH may be used as parameters for the CQI value, and a reference AL may be independently given to the UE.
R_AL may be defined in all of the above methods.
R_AL refers to a reference AL for the MPDCCH. Information suitable for DQI configuration information may be estimated from R_AL. Herein, reference means a parameter that may be assumed for transmission of a hypothetical DL channel in deriving the reception performance of the hypothetical DL channel (e.g., MPDCCH) that DQI is intended to represent.

When there are various DQI report modes (e.g., wideband or subband/narrowband selected or preferred (by the BS or the UE)), a DCI report mode may be determined as follows.
The DQI report mode may be determined by the NB (or NB-IoT carrier) relationship between Msg2 and Msg3/Msg4.
For example, when the NB (or NB-IoT carrier) of Msg2 and the NB (or NB-IoT carrier) of Msg3/Msg4 are different, wideband DQI may be reported. When the NB (or NB-IoT carriers) of Msg2 and the NB (or NB-IoT carrier) of Msg3/Msg4 are the same, NB DQI may be reported.
Depending on whether the NBs (or NB-IoT carriers) of Msg2 and Msg3/Msg4 are different, DQI may be selectively defined as a CQI or a repetition number/AL, and a DQI value range may also be defined differently.

In the above description, a wideband may be based only on actual NBs used for Msg2 transmission by the BS. That is, even when the BS enables frequency hopping for a reference resource (e.g., a Type2 CSS) serving as a reference for DQI measurement, only some frequency resources (NB) may be used for the transmission. For example, when a repetition number is small, the BS may not use all of NBs available for frequency hopping.

E.11 DL Quality Information Report for Non-BL UE

A non-BL UE operating in a CE mode may use two or more Rx antennas, and measure and report DQI based on the Rx antennas. The BS may not have accurate knowledge of the number of Rx antennas of the non-BL UE, and a suitable DQI value range may be different according to the number of Rx antennas used for DQI measurement. In this regard, DQI measurement and reporting of the non-BL UE may have the following features.
The BS may set the number of Rx antennas available for DQI measurement of the UE.
When the UE measures DQI, the UE may measure the DQI based on a single antenna to reduce power consumption. However, if the DQI is a specific value or represents a worse quality, the UE may be forced or configured to measure/report DQI using two or more Rx antennas.

E.12 Method of Measuring and Reporting DL Quality Information in One or More NB-IoT DL Carriers

The UE may be instructed to measure DQI in on one or more NB-IoT DL carriers and report the DQI. Particularly, the network may indicate/configure the DQI measurement and reporting to use the DQI as auxiliary information for DL carrier redirection.
The carrier set may be configured by higher-layer signaling (e.g., system information or an RRC message) or carrier(s) to be measured and reported by the UE in the carrier set configured by the higher-layer signaling may be indicated by DCI (e.g., DCI triggering an (N)PDCCH order-based (N)PRACH).
The carrier set (that the UE should measure) may include a combination of an anchor carrier and one non-anchor carrier (an anchor carrier that may be expected to have been received by the UE in a CE level selection process to reduce additional power consumption caused by measurement of the UE may be added to measurement carriers because the addition of the anchor carrier may not have a significant effect on the reception complexity and power consumption of the UE.)
The measurement period of the anchor carrier may be limited to an (N)PRSRP period for CE level selection.
The measurement period of the non-anchor carrier may be limited to a time period after Msg2 reception.
An additional measurement gap or time may be given to perform the above additional measurement.
If carrier(s) is given to an (N)PDCCH order-based (N)PRACH, an additional time for the UE to transmit Msg3 after the DCI (e.g., the interpretation of a scheduling delay may be extended or different) may be set.
The UE may be allowed not to expect DL scheduling for a specific time before the random access procedure, which may be different according to the position of an NB-IoT DL carrier to be additionally measured by the UE, an operation mode, and a carrier type (e.g., anchor carrier or non-anchor carrier) (i.e., the UE may be allowed not to receive any or part of a specific search space).
The UE may report the measurement result of carrier(s) other than a carrier on which Msg2 associated with Msg1 has been received.
The UE may be configured to select a preferred NB-IoT DL carrier based on the measurement result and report only corresponding information (because there may be a limit on the configuration of a field for measurement reporting).
When the DL channel quality of the carrier is to be reported together with the above information, and when the specific interpretation of the DL channel quality information is changed according to the configuration of Msg2 (e.g., the maximum repetition number of the Msg2 NPDCCH), the DL channel quality information may be determined/interpreted based on the Msg2 configuration of a DL carrier associated with the Msg1 transmission or based on the Msg2 configuration of a DL carrier selected (or reported) based on a measurement.
If there is no Msg2 configuration for the selected carrier, the Msg2 configuration of a DL carrier associated with the existing Msg1 transmission may be followed, or an Msg2 configuration to be referred to may be defined or given separately.
The UE may be allowed to select a preferred NB-IoT DL carrier based on the measurement result and transmit Msg1 on a UL carrier corresponding to a DL carrier in which Msg2 may be expected.
When the preferred NB-IoT DL carrier has been reported, the UE may be configured to perform NPDCCH monitoring related to Msg2 and/or Msg3/4 on the carrier.
The BS may present a reference value for selecting a preferred NB-IoT DL carrier. For example, the BS may limit a repetition number estimated by the UE (which the UE needs to decode a hypothetical NPDCCH in a Type2-CSS with a BLER of 1% upon the NB-IoT DL carrier) not to exceed a specific value.
If only a specific DL carrier is measured (other than an Msg2 carrier associated with Msg1), the UE may measure/report the DQI of the indicated carrier.
If DQI is interpreted/determined based on an Msg2 configuration, Msg2 configuration information may still be based on the carrier of Msg2 associated with Msg1 or the Msg2 configuration of the indicated (measured) carrier.
The preferred carrier may be the most UE-preferred carrier or the least UE-preferred carrier in terms of reception performance.
A preferred carrier is a carrier predicted to have the best DL reception performance, and a non-preferred carrier is a carrier predicted to have the worst DL reception performance. When the least preferred carrier information is reported, the DQI may not include a repetition number or may include a conservative value (e.g., the largest of the repetition numbers of carriers except for the least preferred carrier) out of DQI (repetition numbers) about other carriers. The reason for reporting non-preferred carrier information is that when the BS redirects the DL carrier of the UE, the non-preferred carrier information may be used as information indicating that the UE does not want the carrier to be configured as a DL carrier.
The DQI report may include DQI measured in two or more NB-IoT DL carriers.
The DQI may be transmitted at the same time or may be transmitted at a different time or in different resources.
When the DQI is reported at the same time, the value range and/or representation interval of the DQI may be smaller or narrower than the DQI of one NB-IoT DL carrier.
When there are multiple carriers on which reception of Msg2 may be expected, corresponding to a carrier available for Msg1 transmission, the UE may select a DL carrier with the best DL channel quality (e.g., satisfying a specific reception performance of a specific channel with the smallest repetition number) among the multiple DL carriers and then attempt to transmit Msg1 on a UL carrier corresponding to the selected DL carrier.
The UE may then indicate that Msg1 is transmitted on the UL carrier because of the best DL channel quality of the DL channel corresponding to the UL carrier during the CQI transmission (e.g., in Msg3). This information may be reported together with the CQI required for the selected DL carrier (e.g., the smallest repetition number with which reception of a specific channel may be expected, while satisfying a specific reception performance).
This may be used as indirect information requesting the BS not to allocate the other DL carriers to the UE after the random access procedure.

E.13 Physical UL Channel for DL Quality Information Report

When a CQI is transmitted in Msg3, corresponding information may be transmitted on the (N)PUSCH largely by rate-matching or puncturing. Rate-matching is to allocate data to be transmitted in Msg3 to REs except for REs carrying the CQI in the (N)PUSCH. In this case, there is a need to avoid a mismatch in the number of REs to be used for data transmission between the UE and the BS. For example, when there is a mismatch in the number of REs, the BS may determine a wrong code rate to be referred to for data decoding, thereby failing in the decoding. Puncturing is a scheme of performing data mapping without taking into account the number and positions of REs required for CQI transmission while determining the number of REs available for the data to be transmitted in Msg3. Puncturing is advantageous in that the BS does not determine a wrong code rate for data decoding of Msg3 in spite of no knowledge of whether the UE will transmit a CQI. The above-described rate-matching and puncturing may be selectively applied depending on whether the BS may be aware whether the UE transmits a CQI before the BS attempts to decode data. For example, when a CQI is transmitted in Msg3 in the initial random access procedure, the CQI may be transmitted by puncturing. When a CQI is transmitted in Msg3 in the RRC connected mode by a BS request, rate-matching may be used. Further, when the UE transmits a CQI in BS-preconfigured UL resources (PUR) in the RRC idle mode, rate-matching may be applied. If the PUR is configured in the RRC idle mode, not in the RRC connected mode, the BS may not have information about the UE capability of supporting CQI measurement and reporting. Therefore, puncturing may be applied.

E.14 CQI Reporting in RRC Connected Mode

The BS may redirect the NB-IoT UE to a non-anchor carrier in the random access procedure. That is, a non-anchor carrier other than the DL carrier on which the UE has received Msg2 and Msg4 (i.e., other than a DL carrier from which the CQI has been derived and reported in Msg3 by the UE) may be allocated to the UE, and then the UE may be requested to perform a subsequent operation on the configured non-anchor carrier. In this case, since the BS has no knowledge of the CQI of the non-anchor carrier of the UE, the BS may need to request the UE to measure a CQI in the configured carrier and report the CQI, apart from the CQI reported by the UE in the random access procedure. This may be performed based on the procedure of reporting a CQI on an (N)PUSCH (hereinafter referred to as Msg3) indicated by Msg2 in an (N)PDCCH order-based random access procedure. In this case, whether to report a CQI in Msg3 may be indicated using a reserved bit (‘R’ bit) unused in the MAC RAR of Msg2. However, since there may not be enough time to measure the CQI after successful detection of Msg2, whether to report the CQI in Msg3 may be indicated by a specific state or bit that is not used or is always set to a specific value in DCI that triggers Msg1 transmission (e.g., DCI requesting (N)PDCCH order-based Msg1 transmission).

The CQI measured by the UE may be defined differently from the CQI reported in the random access procedure. For example, since there is no information about a USS in the initial random access procedure, a CQI may be defined based on a parameter related to a resource configuration for detecting Msg2 (e.g., a maximum repetition number for a type-2 CSS), whereas when CQI measurement and reporting are requested in the RRC connected mode as described above, a CQI may be defined based on an already configured USS-related parameter (e.g., a maximum repetition number). For example, the CQI may be defined as an actual repetition number with which a PDCCH (e.g., MPDCCH or (N)PDCCH) related to Msg2 has been successfully detected or a repetition number required to decode a (hypothetical) PDCCH (e.g., MPDCCH or (N)PDCCH). In this case, the CQI may be defined based on a maximum repetition number. In a more specific example, the CQI may be defined as a ratio to the maximum repetition number Rmax. When the actual repetition number with which the PDCCH (e.g., MPDCCH or (N)PDCCH) related to Msg2 has been successfully detected or the repetition number required to decode the (hypothetical) PDCCH (e.g., MPDCCH or (N)PDCCH) is reported as one of {1, 2, 4, 8, . . . }, the CQI may be defined as one of {Rmax, Rmax/2, Rmax/4, Rmax/8, . . . }.

Further, the CQI may be defined based on a CSS or a USS which has a larger or smaller maximum repetition number, or one of the CSS and the USS may be selected by specific signaling from the BS. Even when the CQI is defined based on the USS, an NRS received for CQI measurement by the UE may be included in CSS Type 2 because the NRS may always be expected in a type 2 CSS on the non-anchor carrier. When the BS indicates an NPDCCH order-based NPDCCH transmission, the BS may configure the CE level of Msg1 resources to be different from an actual CE level of the UE. However, the UE may derive a CQI based on its DL CE level, not the CE level related to Msg1, indicated by the BS.

E.15 Method of Reporting CQI in PUR in RRC Idle Mode

When the UE transmits an (N)PUSCH in a PUR configured by the BS in the RRC idle mode, and when the UE is to monitor a DL channel for such as reason as reception of feedback information for the PUR transmission, the BS may need a CQI from the UE. That is, the BS may use the DL CQI of the UE to configure a repetition number and/or an AL and/or a code rate (which may be determined by a resource size and an MCS), for an (N)PDCCH/MPDCCH and/or an (N)PDSCH. The BS needs the CQI for a similar reason to a reason for which the BS needs a CQI of the UE in the initial random access procedure. However, since a used UL channel structure is different from that in the initial random access procedure in terms of PUR transmission, the following features may be needed additionally.

1) CQI Definition

A. Since the DL feedback channel structure may be different according to a PUR type, the CQI definition may be related to the PUR type.

\textcircled{1} There are a PUR type in which time/frequency resources are UE-dedicated, a PUR type in which time/frequency resources are sharable among multiple UEs, with spatial and/or code resources configured in a UE-dedicated manner, (e.g., collision may occur but with no contention), and a PUR type in which all resources are sharable among multiple UEs (e.g., contention may occur).

\textcircled{2} Depending on a PUR type, the structure of a DL channel monitored by the UE may be different. For example, the DL channel to be monitored may be shared among multiple users (e.g., a structure similar to the RAR of Msg2) or a DL channel to be monitored may be configured for each user (e.g., an (N)PDCCH/MPDCCH of a USS). When a DL channel is defined independently for each user, a CQI is reported on a user basis. On the contrary, in the case where multiple users share and decode a DL channel, when user information exists for each individual user or for each group, only a specific user may be configured to report a CQI. This is because the channel should be scheduled based on the reception performance of a UE with the worst of the DL channel qualities of users sharing the DL channel. Further, the BS may configure a CQI to be reported only when a specific condition is or is not satisfied. The specific condition may mean, for example, that a CQI measured by a UE is less than a specific value. The CQI may be different from a CQI for the initial access procedure. A reference channel required to derive a CQI may be defined according to a PUR type and/or a DL channel. Further, when a PUR is configured for the UE in the RRC connected mode, the UE may be configured to report a CQI in a PUR in the RRC idle mode only as a delta value from the existing CQI based on some attribute of DL channel parameters because the BS may have already had DL channel quality information and thus have configured DL channel parameters based on the DL channel quality information.

\textcircled{3} In the case of CQI transmission in a PUR, the CQI may be defined as the repetition number and/or AL of the (N)PDCCH or MPDCCH, rather than it is defined based on the PDSCH regardless of the CE mode.

2) CQI Measurement Time

A. CQI measurement and reporting may be performed only when DL reception is required to determine whether to continue PUR transmission, not in every PUR transmission unit. That is, only when an operation of determining whether a configured PUR is still valid in consideration of a change in an ambient environment of the UE is performed, such an operation may be restrictively required.

E.16 Method of Reporting CQI of Control Channel in RRC Connected Mode

The present disclosure proposes a method of reporting the CQI of a DL control channel (e.g., MPDCCH, NPDCCH, or PDSCH) by a UE, which may be applied irrespective of the RRC states. However, a control channel that the UE attempts to detect in the RRC connected mode may be different from a control channel that the UE attempts to detect in the RRC idle mode. Accordingly, a CQI may be measured and reported in different methods in the RRC connected mode and the RRC idle mode. In this section, a series of procedures related to the method of reporting the CQI of a DL control channel in the RRC_CONNECTED mode are proposed. While the proposed method is described in the context of an MPDCCH in an eMTC system for the convenience of explanation, it may also be applied to other communication systems such as NB-IoT, LTE, and NR. Specific examples and channel/signal names in the proposed method may be interpreted as examples and channel/signal names intended to serve the same/similar purpose in the corresponding other systems.

1) Reference MPDCCH Format for Measuring CQI

A. Unlike the RRC idle mode, the UE may monitor an MPDCCH in a USS configured on a UE basis in the RRC connected mode. Considering that even though each UE monitors the same DCI format (e.g., DCI formats 6-0A and 6-1A or DCI formats 6-0B and 6-1B), the DCI size of a USS may be different according to a UE capability (e.g., sub-PRB, 64QAM, or wideband support or non-support), a CQI may be measured/calculated in a different reference channel (e.g., hypothetical MPDCCH). Further, because a UE in CE Mode A may monitor not only a USS but also a Type0-CSS in the RRC connected mode, a reference format for CQI measurement (and/or a search space type-only for CE mode A) may be configured by the BS or defined by a specific agreement. That is, even for the same UE, the size of the reference format may be changed according to parameter information configured for the USS with reference to the capability of the UE by the BS.

B. An ECCE is an MPDCCH allocation unit. A minimum number of ECCEs included in an MPDCCH may be different in each subframe carrying the MPDCCH, and thus the reference for a CQI may vary. That is, when the CQI is a value representing the repetition number and/or AL of the MPDCCH (e.g., a value that may satisfy a specific criterion for hypothetical MPDCCH reception detection performance), a reference MPDCCH format from which the CQI is derived (e.g., see TS36.211 Table 6.8B.1-2) may be “indicated by the BS”, “fixed in the standard”, or “fixed and signaled at a time when an MPDCCH triggering CQI reporting (an MPDCCH indicating CQI reporting in an aperiodic CQI triggering manner) is received or at a relative time from the time.

2) CQI Information Configuration

A. When a “maximum repetition number Rmax configured for the search space of a reference MPDCCH format (a maximum number of times an MPDCCH may be repeated in the search space) or a maximum value which may be reported in a CQI (e.g., an MPDCCH repetition number required for the UE to detect a hypothetical MPDCCH with performance equal to or higher than specific reference performance) (referred to as B) is less than “the number of hopping NBs used for MPDCCH transmission x an available repetition number for an MPDCCH subframe in each hop)” (referred to as A), as much resources as A may be divided into resource parts each corresponding to a size B, a CQI may be derived for each resource part, and the worst (or best) CQI (e.g., lowest (or highest) in terms of efficiency) may be selected as a representative CQI. Information about the resource part based on which the CQI has been derived may also be included in the CQI.

B. Since a USS may be configured on a UE basis, each UE may include, in a CQI, its preferred MPDCCH or USS configuration (e.g., a configuration by which MPDCCH detection performance satisfies specific reference performance by using minimum resources) among various available MPDCCH or USS configurations, and report the CQI to the BS. The BS may change MPDCCH configuration information of the UE by reflecting the CQI. The following information may be included in the preferred MPDCCH or USS configuration.

\textcircled{1} MPDCCH resource mapping scheme (e.g., distributed mapping or localized mapping)

\textcircled{2} MPDCCH hopping enable/disable information (characteristically, this information may be restrictively included in the CQI, only when the MPDCCH hopping configuration is enabled at a time of triggering MPDCCH CQI reporting).

\textcircled{3} When there are two or more MPDCCH PRB sets (e.g., see TS36.213 Table 9.1.5-1a, Table 9.1.5-1b, Table 9.1.5-2a, and Table 9.1.5-2b), information about an assumed PRB set or a UE-preferred MPDCCH PRB set in deriving a CQI.

3) Additional Features when the Relationship Between a CRS Port and an MPDCCH DMRS Port is Used

The MPDCCH is transmitted by the same precoding as used for a DMRS port related to an ECCE included in the MPDCCH. Precoding information applied to a corresponding DMRS based on a CRS is generally not provided to the UE. If all or some of the above information may be additionally provided for the purpose of, for example, improvement of MPDCCH detection performance, the UE may additionally report related information (e.g., the relationship between an MPDCCH DMRS port and a CRS port) to the BS, together with or separately from the CQI.

A. When precoder information about the CRS and DMRS ports may be fixed to a specific value or cycled in every specific time/frequency unit, the UE may report UE-preferred precoding information (e.g., which may include information indicating that cycling is preferred or information requesting use of a specific precoder or cycling in a specific way). Further, the BS may indicate a precoder relationship between assumed CRS and DMRS ports, when the UE derives an MPDCCH CQI. Obviously, the information may be for indicating assumption of a specific precoder, or may indicate that it is not necessary to assume a specific precoder combination.

B. The UE may be configured to assume precoder information (e.g., a PMI) included in the most recent CSI report for a PDSCH (or the most recent CSI report for the PDSCH before a specific time) as precoder information to be assumed when the UE calculates an MPDCCH CQI (e.g., the repetition number and/or AL of the hypothetical MPDCCH).

E.17 Flowcharts of Operations According to the Proposals of the Present Disclosure

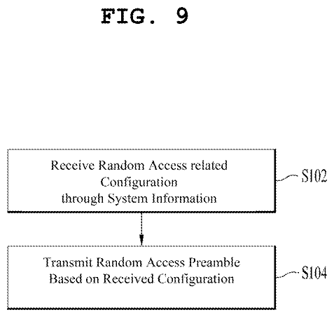

FIG. 9 is a flowchart illustrating a method of transmitting (or reporting) information regarding DQI in Msg1 to a BS by a UE. The example of FIG. 9 may be performed by the UE in the RRC_IDLE state or the RRC_CONNECTED state. In the description of FIG. 9, (RA-0) to (RA-4) refer to the random access procedure described in section E. As described before, the term UE may be replaced with the terms user equipment, MS, UT, SS, MT, and wireless device.

In step S102, the UE may receive random access related configuration information through system information (or an SIB) from the BS. For example, step S102 may correspond to step (RA-0). Accordingly, the UE may receive the system information (or SIB) including the random access related configuration information according to the operation described in relation to step (RA-0) and/or the operation proposed in the present disclosure (e.g., see section E.1 to section E.16).

In step S104, the UE may transmit a random access preamble (or Msg1) to the BS based on the received configuration information. For example, step S104 may correspond to step (RA-1). In step S104, the UE may further transmit information regarding DQI through the random access preamble to the BS according to the present disclosure. To transmit the information regarding DQI through the random access preamble, the UE may perform the operation described in relation to step (RA-1), the operation described in section E.1, and/or the operation proposed in the present disclosure (e.g., see section E.2 to section E.16).

After step S104, the UE may perform the same operations as steps (RA-2), (RA-3), and (RA-4).

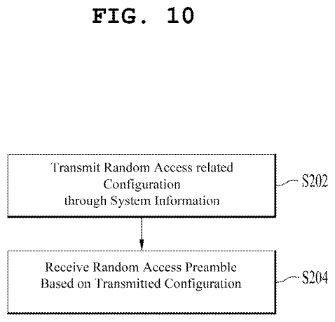

FIG. 10 is a flowchart illustrating a method of receiving (or receiving a report of) information regarding DQI in Msg1 from a UE by a BS. In the example of FIG. 10, the BS may perform the method with a UE in an RRC_IDLE state. In the description of FIG. 10, step (RA-0) to step (RA-4) refer to the random access procedure described in section E. As described above, a BS is a wireless device that communicates with a UE and the term BS is interchangeably used with other terms such as eNB, gNB, BTS, and AP.

In step S202, the BS may transmit random access related configuration information through system information (or an SIB) to the UE. For example, step S202 may correspond to step (RA-0). Accordingly, the BS may transmit to the UE the system information (or SIB) including the random access related configuration information according to the operation described in relation to step (RA-0) and/or the operation proposed in the present disclosure (e.g., see section E.1 to section E.16).

In step S204, the BS may receive a random access preamble (or Msg1) from the UE based on the transmitted configuration information. For example, step S204 may correspond to step (RA-1). In step S204, the BS may further receive information regarding DQI through the random access preamble from the UE according to the present disclosure. To receive the information regarding DQI through the random access preamble, the BS may perform the operation described in relation to step (RA-1), the operation described in section E.1, and/or the operation proposed in the present disclosure (e.g., see section E.2 to section E.16).

After step S204, the BS may perform the same processes as steps (RA-2), (RA-3), and (RA-4).

As described above, the UE may provide the DQI in step (RA-3) so that the BS may use the DQI for DL scheduling in step (RA-4).

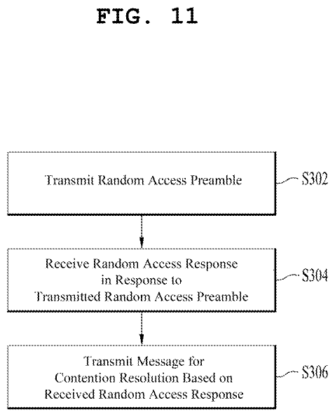

FIG. 11 is a flowchart illustrating a method of transmitting (or reporting) information regarding DQI in Msg3 to a BS by a UE. The example of FIG. 11 may be performed by a UE in an RRC_IDLE state. In the description of FIG. 11, step (RA-0) to step (RA-4) refer to the random access procedure described in section E. As described above, the term UE is interchangeably used with other terms such as user equipment, MS, UT, SS, MT, and wireless device.

In step S302, the UE may transmit a random access preamble (or Msg1) to the BS. For example, step S302 may correspond to step (RA-1). Accordingly, the UE may transmit the random access preamble to the BS according to the operation of step (RA-1) and/or the operation proposed in the present disclosure. A configuration for the random access preamble transmission may be preset according to the operation of step (RA-0) and/or the operation proposed in the present disclosure (e.g., see section E.1 to section E.16). For example, an operation corresponding to step (RA-0) may be performed before step S302 (not shown), and reporting of information regarding DCI through Msg3 may be enabled based on system information broadcast by the BS.

In step S304, the UE may receive an RAR (or Msg2) from the BS in response to the transmitted random access preamble (or Msg1). For example, step S304 may correspond to step (RA-2), and the RAR may include information described herein and/or information proposed by the present disclosure. The UE may receive the RAR from the BS according to the operation of step (RA-2) and/or the operation proposed in the present disclosure (e.g., see section E.1 to section E.16). For example, the RAR may include an indication (or information) indicating the UE to report information regarding the DQI through Msg3.

In step S306, the UE may transmit a message for contention resolution (or Msg3) to the BS on a physical UL channel (e.g., PUSCH or NPUSCH) based on the received RAR (or Msg2). For example, step S306 may correspond to step (RA-3). In step S306, the UE may further transmit the information regarding DQI through the physical UL channel (e.g., PUSCH or NPUSCH) (or through the message for contention resolution) to the BS according to the present disclosure. To this end, the physical UL channel (e.g., PUSCH or NPUSCH) (or the message for contention resolution) may include information described herein and/or information proposed by the present disclosure. The UE may transmit information regarding the DQI through the physical uplink channel (e.g., PUSCH or NPUSCH) (or through the message for contention resolution) according to the operation of step (RA-3) and/or the operation proposed in the present disclosure (e.g., see section E.1 to section E.16). For example, information regarding the DQI may be transmitted to the BS through a higher-layer signal (e.g., a MAC message or an RRC message).

After step S306, the UE may perform the same process as in step (RA-4).

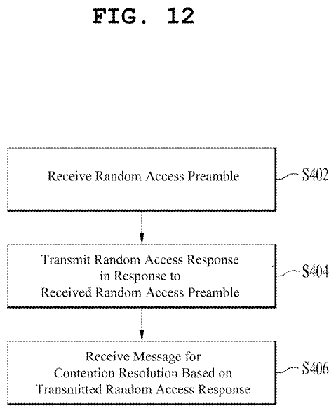

FIG. 12 is a flowchart illustrating a method of receiving (a report of) information regarding DQI through Msg 3 from a UE. In the example of FIG. 12, the BS may perform the method with the UE in an RRC_IDLE state. In the description of FIG. 12, step (RA-0) to step (RA-4) refer to the random access procedure described in section G. As described above, a BS is a wireless device that communicates with a UE, and the term BS is interchangeably used with other terms such as eNB, gNB, BTS, and AP.

In step S402, the BS may receive a random access preamble (or Msg1) from the UE. For example, step S402 may correspond to step (RA-1). Accordingly, the BS may receive the random access preamble from the UE according to the operation of step (RA-1) and/or the operation proposed in the present disclosure. A configuration for the random access preamble transmission may be preset according to the operation of step (RA-0) and/or the operation proposed in the present disclosure (e.g., see section E.1 to section E.16).

In step S404, the BS may transmit an RAR (or Msg2) to the UE in response to the received random access preamble (or Msg1). For example, step S404 may correspond to step (RA-2), and the RAR may include information described herein and/or information proposed in the present disclosure. The BS may transmit the RAR to the UE according to the operation of step (RA-2) and/or the operation proposed in the present disclosure (e.g., see section E.1 to section E.16).

In step S406, the BS receives a message for contention resolution (or Msg3) through a physical UL channel (e.g., PUSCH or NPUSCH) from the UE in response to the transmitted RAR (or Msg2). For example, step S406 may correspond to step (RA-3). In step S406, the BS may further receive information regarding the DQI through the physical UL channel (e.g., PUSCH or NPUSCH) (or through the message for contention resolution) from the UE according to the present disclosure. To this end, the physical UL channel (e.g., PUSCH or NPUSCH) (or the message for contention resolution) may include information described herein and/or information proposed in the present disclosure. The BS may receive the information regarding DQI through the physical UL channel (e.g., PUSCH or NPUSCH) (or through the message for contention resolution) from the UE according to the operation of step (RA-3) and/or the operation proposed in the present disclosure (e.g., see section E.1 to section E.16).

After step S406, the BS may perform the same process as in step (RA-4).

In the examples of FIGS. 9 to 12, the operations described herein and/or the operations proposed in the present disclosure (e.g., see section E.1 to section E.16) may be performed in combination with the UE operations or the BS operations without limitation. All of the contents of “E. Proposed Methods of the Present Disclosure” are incorporated by reference in the descriptions of FIGS. 9 to 12.

By way of a non-limiting example, as proposed in the present disclosure, the DQI may include RSRP and/or RSRQ information, a repetition number R and/or an AL related to decoding of an actual PDCCH (MPDCCH or NPDCCH), a repetition number R and/or an AL related to decoding of a hypothetical PDCCH (MPDCCH or NPDCCH), a repetition number R related to decoding of an actual PDSCH (or NPDSCH), a repetition number R related to decoding of a hypothetical PDSCH (or NPDSCH), CQI information, or a combination of at least two thereof (e.g., see sections E.1.1, E.6, E.9, and E.10).

In a more specific example, as proposed in the present disclosure, the DQI may include information indicating the repetition number of a physical DL control channel (e.g., PDCCH, MPDCCH, or NPDCCH) related to an RAR at a time of detecting the physical DL control channel. In this example, the DQI may further include information indicating the AL of the physical DL control channel (e.g., PDCCH, MPDCCH, or NPDCCH) related to the RAR at the time of detecting the physical DL control channel. Alternatively, when the repetition number of the physical DL control channel satisfies a specific performance requirement, the DQI may be transmitted on the assumption that the AL of the physical DL control channel related to the RAR is a reference AL (e.g., 24), and the specific performance requirement may include the repetition number of the physical DL control channel being 1.

In another specific example, as proposed in the present disclosure, the DQI may include information indicating a repetition number required to detect a hypothetical physical DL control channel at a specific BLER, and the specific BLER may be, for example, 1%. In this example, the DQI may further include information indicating an AL required to detect the hypothetical physical DL control channel at the specific BLER. Alternatively, when the repetition number required to detect the hypothetical physical DL control channel satisfies a specific performance requirement, the DQI may be transmitted on the assumption of the AL as a reference AL (e.g., 24), and the specific performance requirement may include the repetition number required to detect the hypothetical physical DL control channel being 1.

H. Communication System and Devices to which the Present Disclosure is Applied

Various descriptions, functions, procedures, proposals, methods, and/or operation flowcharts of the present disclosure described herein may be applied to, but not limited to, various fields requiring wireless communication/connection (e.g., 5G) between devices.

The communication system and devices will be described in detail with reference to the drawings. Unless otherwise specified, like reference numerals denote the same or corresponding hardware blocks, software blocks, or functional blocks in the drawings/description.

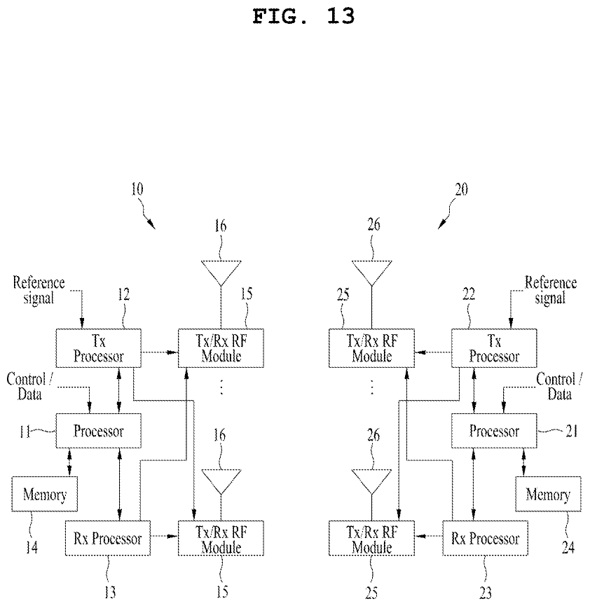

FIG. 13 illustrates a block diagram of a wireless communication apparatus to which the methods proposed in the present disclosure are applicable.

Referring to FIG. 13, a wireless communication system includes a BS 10 and multiple UEs 20 located within coverage of the BS 10. The BS 10 and the UE may be referred to as a transmitter and a receiver, respectively, and vice versa. The BS 10 includes a processor 11, a memory 14, at least one Tx/Rx radio frequency (RF) module (or RF transceiver) 15, a Tx processor 12, an Rx processor 13, and an antenna 16. The UE 20 includes a processor 21, a memory 24, at least one Tx/Rx RF module (or RF transceiver) 25, a Tx processor 22, an Rx processor 23, and an antenna 26. The processors are configured to implement the above-described functions, processes and/or methods. Specifically, the processor 11 provides a higher layer packet from a core network for DL transmission (communication from the BS to the UE). The processor implements the functionality of layer 2 (L2). In DL, the processor provides the UE 20 with multiplexing between logical and transmission channels and radio resource allocation. That is, the processor is in charge of signaling to the UE. The Tx processor 12 implements various signal processing functions of layer 1 (L1) (i.e., physical layers). The signal processing functions include facilitating the UE to perform forward error correction (FEC) and performing coding and interleaving. Coded and modulated symbols may be divided into parallel streams. Each stream may be mapped to an OFDM subcarrier, multiplexed with an RS in the time and/or frequency domain, and then combined together using an inverse fast Fourier transform (IFFT) to create a physical channel carrying a time domain OFDMA symbol stream. The OFDM stream is spatially precoded to produce multiple spatial streams. Each spatial stream may be provided to a different antenna 16 through the Tx/Rx module (or transceiver) 15. Each Tx/Rx module may modulate an RF carrier with each spatial stream for transmission. At the UE, each Tx/Rx module (or transceiver) 25 receives a signal through each antenna 26 thereof. Each Tx/Rx module recovers information modulated on the RF carrier and provides the information to the RX processor 23. The Rx processor implements various signal processing functions of layer 1. The Rx processor may perform spatial processing on the information to recover any spatial streams toward the UE. If multiple spatial streams are destined for the UE, the multiple spatial streams may be combined by multiple Rx processors into a single OFDMA symbol stream. The RX processor converts the OFDMA symbol stream from the time domain to the frequency domain using a fast Fourier transform (FFT). A frequency-domain signal includes a separate OFDMA symbol stream for each subcarrier of an OFDM signal. The symbols and the reference signal on each subcarrier are recovered and demodulated by determining the most probable signal constellation points transmitted by the BS. Such soft decisions may be based on channel estimation values. The soft decisions are decoded and deinterleaved to recover data and control signals originally transmitted by the BS over the physical channel. The corresponding data and control signals are provided to the processor 21.

UL transmission (communication from the UE to the BS) is processed by the BS10 in a similar way to that described in regard to the receiver functions of the UE 20. Each Tx/Rx module (or transceiver) 25 receives a signal through each antenna 26. Each Tx/Rx module provides an RF carrier and information to the Rx processor 23. The processor 21 may be connected to the memory 24 storing program codes and data. The memory may be referred to as a computer-readable medium.

The present disclosure described above may be carried out by the BS 10 and the UE 20 which are wireless communication devices illustrated in FIG. 13.

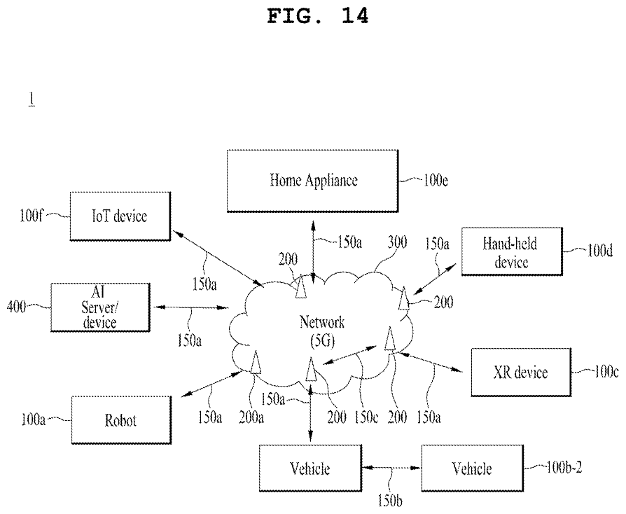

FIG. 14 illustrates a communication system 1 applied to the present disclosure.

Referring to FIG. 14, the communication system 1 applied to the present disclosure includes wireless devices, BSs, and a network. The wireless devices refer to devices performing communication by radio access technology (RAT) (e.g., 5G New RAT (NR) or LTE), which may also be called communication/radio/5G devices. The wireless devices may include, but no limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle equipped with a wireless communication function, an autonomous driving vehicle, and a vehicle capable of performing vehicle-to-vehicle (V2V) communication. The vehicles may include an unmanned aerial vehicle (UAV) (e.g., a drone). The XR device may include an augmented reality (AR)/virtual reality (VR)/mixed reality (MR) device, and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smart glasses), and a computer (e.g., a laptop). The home appliance may include a TV, a refrigerator, and a washing machine. The IoT device may include a sensor and a smart meter. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured by using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f and the BSs 200, or between the BSs 200. Herein, the wireless communication/connections may be established through various RATs (e.g., 5G NR) such as UL/DL communication 150a, sidelink communication 150b (or, D2D communication), or inter-BS communication 150c (e.g. relay, integrated access backhaul (IAB)). A wireless device and a BS/a wireless devices, and BSs may transmit/receive radio signals to/from each other through the wireless communication/connections 150a, 150b, and 150c. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

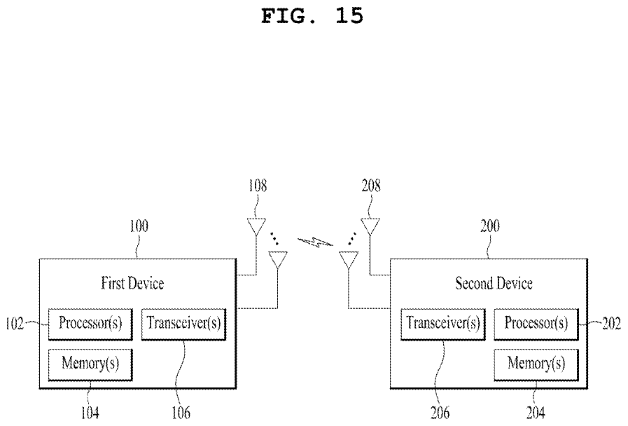

FIG. 15 illustrates wireless devices applicable to the present disclosure.

Referring to FIG. 15, a first wireless device 100 and a second wireless device 200 may transmit radio signals through a variety of RATs (e.g., LTE and NR). Herein, {the first wireless device 100 and the second wireless device 200} may correspond to {the wireless devices 100a to 100f and the BSs 200} and/or {the wireless devices 100a to 100f and the wireless devices 100a to 100f} of FIG. 14.

The first wireless device 100 may include at least one processor 102 and at least one memory 104, and may further include at least one transceiver 106 and/or at least one antenna 108. The processor 102 may control the memory 104 and/or the transceiver 106 and may be configured to implement the descriptions, functions, procedures, proposals, methods, and/or operational flowcharts disclosed in this document. For example, the processor 102 may process information within the memory 104 to generate first information/signal and then transmit a radio signal including the first information/signal through the transceiver 106. The processor 102 may receive a radio signal including second information/signal through the transceiver 106 and then store information obtained by processing the second information/signal in the memory 104. The memory 104 may be coupled to the processor 102 and store various types of information related to operations of the processor 102. For example, the memory 104 may store software code including commands for performing a part or all of processes controlled by the processor 102 or for performing the descriptions, functions, procedures, proposals, methods, and/or operational flowcharts disclosed in this document. Herein, the processor 102 and the memory 104 may be a part of a communication modem/circuit/chip designed to implement an RAT (e.g., LTE or NR). The transceiver 106 may be coupled to the processor 102 and transmit and/or receive radio signals through the at least one antenna 108. The transceiver 106 may include a transmitter and/or a receiver. The transceiver 106 may be interchangeably used with an RF unit. In the present disclosure, a wireless device may refer to a communication modem/circuit/chip.

The second wireless device 200 may include at least one processor 202 and at least one memory 204, and may further include at least one transceiver 206 and/or at least one antenna 208. The processor 202 may control the memory 204 and/or the transceiver 206 and may be configured to implement the descriptions, functions, procedures, proposals, methods, and/or operational flowcharts disclosed in this document. For example, the processor 202 may process information within the memory 204 to generate third information/signal and then transmit a radio signal including the third information/signal through the transceiver 206. The processor 202 may receive a radio signal including fourth information/signal through the transceiver 206 and then store information obtained by processing the fourth information/signal in the memory 204. The memory 204 may be coupled to the processor 202 and store various types of information related to operations of the processor 202. For example, the memory 204 may store software code including commands for performing a part or all of processes controlled by the processor 202 or for performing the descriptions, functions, procedures, proposals, methods, and/or operational flowcharts disclosed in this document. Herein, the processor 202 and the memory 204 may be a part of a communication modem/circuit/chip designed to implement an RAT (e.g., LTE or NR). The transceiver 206 may be coupled to the processor 202 and transmit and/or receive radio signals through the at least one antenna 208. The transceiver 206 may include a transmitter and/or a receiver. The transceiver 206 may be interchangeably used with an RF unit. In the present disclosure, a wireless device may refer to a communication modem/circuit/chip.

Hereinafter, hardware elements of the wireless devices 100 and 200 will be described in greater detail. One or more protocol layers may be implemented by, but not limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more protocol data units (PDUs) and/or one or more service data units (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented in hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented in firmware or software, which may be configured to include modules, procedures, or functions. Firmware or software configured to perform the descriptions, functions, procedures, proposals, methods, and/or operational flowcharts disclosed in this document may be included in the one or more processors 102 and 202, or may be stored in the one or more memories 104 and 204 and executed by the one or more processors 102 and 202. The descriptions, functions, procedures, proposals, methods, and/or operational flowcharts disclosed in this document may be implemented as code, instructions, and/or a set of instructions in firmware or software.

The one or more memories 104 and 204 may be coupled to the one or more processors 102 and 202 and store various types of data, signals, messages, information, programs, code, instructions, and/or commands. The one or more memories 104 and 204 may be configured as read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be coupled to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be coupled to the one or more processors 102 and 202 and transmit and receive radio signals. For example, the one or more processors 102 and 202 may control the one or more transceivers 106 and 206 to transmit user data, control information, or radio signals to one or more other devices. The one or more processors 102 and 202 may control the one or more transceivers 106 and 206 to receive user data, control information, or radio signals from one or more other devices. The one or more transceivers 106 and 206 may be coupled to the one or more antennas 108 and 208 and configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

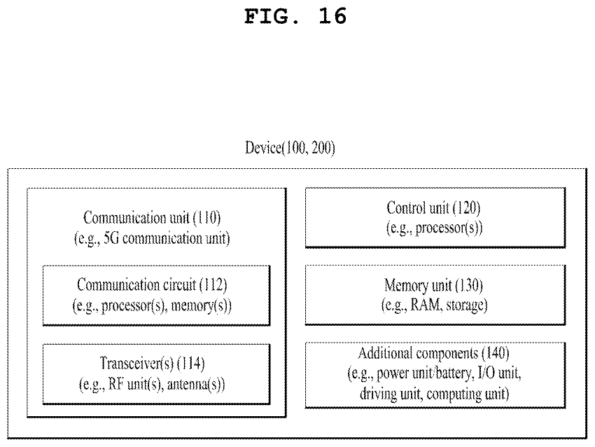

FIG. 16 illustrates another example of wireless devices applied to the present disclosure. The wireless devices may be implemented in various forms according to use-cases/services (refer to FIG. 14).

Referring to FIG. 16, wireless devices 100 and 200 may correspond to the wireless devices 100 and 200 of FIG. 15 and may be configured as various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 15. For example, the transceiver(s) 114 may include the one or more transceivers 106 and 206 and/or the one or more antennas 108 and 208 of FIG. 15. The control unit 120 is electrically coupled to the communication unit 110, the memory unit 130, and the additional components 140 and provides overall control to operations of the wireless devices. For example, the control unit 120 may control an electric/mechanical operation of the wireless device based on programs/code/commands/information stored in the memory unit 130. The control unit 120 may transmit the information stored in the memory unit 130 to the outside (e.g., other communication devices) via the communication unit 110 through a wireless/wired interface or store, in the memory unit 130, information received through the wireless/wired interface from the outside (e.g., other communication devices) via the communication unit 110.

The additional components 140 may be configured in various manners according to the types of wireless devices. For example, the additional components 140 may include at least one of a power unit/battery, an input/output (I/O) unit, a driver, and a computing unit. The wireless device may be configured as, but not limited to, the robot (100a of FIG. 14), the vehicles (100b-1 and 100b-2 of FIG. 14), the XR device (100c of FIG. 14), the hand-held device (100d of FIG. 14), the home appliance (100e of FIG. 14), the IoT device (100f of FIG. 14), a digital broadcasting terminal, a hologram device, a public safety device, an MTC device, a medicine device, a FinTech device (or a finance device), a security device, a climate/environment device, the AI server/device (400 of FIG. 14), the BSs (200 of FIG. 14), a network node, etc. The wireless device may be mobile or fixed according to a use-case/service.

In FIG. 16, all of the various elements, components, units/portions, and/or modules in the wireless devices 100 and 200 may be coupled to each other through a wired interface or at least a part thereof may be wirelessly coupled to each other through the communication unit 110. For example, in each of the wireless devices 100 and 200, the control unit 120 and the communication unit 110 may be coupled wiredly, and the control unit 120 and first units (e.g., 130 and 140) may be wirelessly coupled through the communication unit 110. Each element, component, unit/portion, and/or module within the wireless devices 100 and 200 may further include one or more elements. For example, the control unit 120 may be configured as a set of one or more processors. For example, the control unit 120 may be configured as a set of a communication control processor, an application processor, an electronic control unit (ECU), a graphical processing unit, and a memory control processor. In another example, the memory unit 130 may be configured as a random access memory (RAM), a dynamic RAM (DRAM), a read only memory (ROM), a flash memory, a volatile memory, a non-volatile memory, and/or a combination thereof.

An implementation example of FIG. 16 will be described in detail with reference to the drawings.

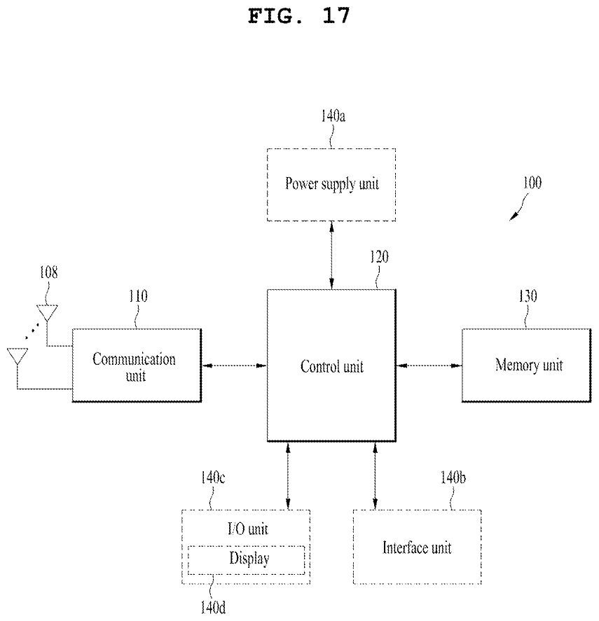

FIG. 17 illustrates a portable device applied to the present disclosure. The portable device may include a smartphone, a smartpad, a wearable device (e.g., a smart watch and smart glasses), and a portable computer (e.g., a laptop). The portable device may be referred to as a mobile station (MS), a user terminal (UT), a mobile subscriber station (MSS), a subscriber station (SS), an advanced mobile station (AMS), or a wireless terminal (WT).

Referring to FIG. 17, a portable device 100 may include an antenna unit 108, a communication unit 110, a control unit 120, a power supply unit 140a, an interface unit 140b, and an I/O unit 140c. The antenna unit 108 may be configured as a part of the communication unit 110. The blocks 110 to 130/140a to 140c correspond to the blocks 110 to 130/140 of FIG. 16, respectively.

The communication unit 110 may transmit and receive signals (e.g., data and control signals) to and from another wireless device and a BS. The control unit 120 may perform various operations by controlling elements of the portable device 100. The control unit 120 may include an application processor (AP). The memory unit 130 may store data/parameters/programs/code/commands required for operation of the portable device 100. Further, the memory unit 130 may store input/output data/information. The power supply unit 140a may supply power to the portable device 100, and include a wired/wireless charging circuit and a battery. The interface unit 140b may include various ports (e.g., an audio I/O port and a video I/O port) for connectivity to external devices The I/O unit 140c may acquire information/signals (e.g., touch, text, voice, images, and video) input by a user, and store the acquired information/signals in the memory unit 130. The communication unit 110 may receive or output video information/signal, audio information/signal, data, and/or information input by the user. The I/O unit 140c may include a camera, a microphone, a user input unit, a display 140d, a speaker, and/or a haptic module.

For example, for data communication, the I/O unit 140c may acquire information/signals (e.g., touch, text, voice, images, and video) received from the user and store the acquired information/signal sin the memory unit 130. The communication unit 110 may convert the information/signals to radio signals and transmit the radio signals directly to another device or to a BS. Further, the communication unit 110 may receive a radio signal from another device or a BS and then restore the received radio signal to original information/signal. The restored information/signal may be stored in the memory unit 130 and output in various forms (e.g., text, voice, an image, video, and a haptic effect) through the I/O unit 140c.

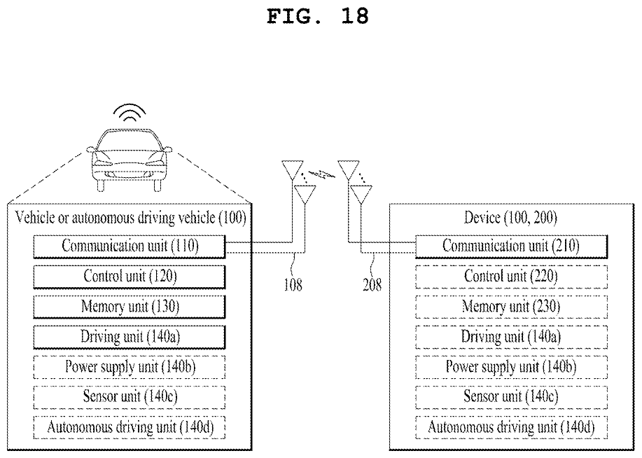

FIG. 18 illustrates a vehicle or an autonomous driving vehicle applied to the present disclosure. The vehicle or autonomous driving vehicle may be configured as a mobile robot, a car, a train, a manned/unmanned aerial vehicle (AV), a ship, or the like.

Referring to FIG. 18, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 16, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to travel on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire vehicle state information, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement a technology for maintaining a lane on which a vehicle is driving, a technology for automatically adjusting speed, such as adaptive cruise control, a technology for autonomously traveling along a determined path, a technology for traveling by automatically setting a path, when a destination is set, and the like.

For example, the communication unit 110 may receive map data, traffic information data, and so on from an external server. The autonomous driving unit 140d may generate an autonomous driving path and a driving plan from the obtained data. The control unit 120 may control the driving unit 140a such that the vehicle or autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain vehicle state information and/or ambient environment information. The autonomous driving unit 140d may update the autonomous driving path and the driving plan based on the newly obtained data/information. The communication unit 110 may transmit information about a vehicle position, the autonomous driving path, and/or the driving plan to the external server. The external server may predict traffic information data using AI technology or the like, based on the information collected from vehicles or autonomous driving vehicles and provide the predicted traffic information data to the vehicles or the autonomous driving vehicles.

The embodiments of the present disclosure described hereinbelow are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or features of any one embodiment may be included in another embodiment and may be replaced with corresponding constructions or features of another embodiment. It is obvious to those skilled in the art that claims that are not explicitly cited in each other in the appended claims may be presented in combination as an embodiment of the present disclosure or included as a new claim by a subsequent amendment after the application is filed.

### INDUSTRIAL APPLICABILITY

The present disclosure is applicable to wireless communication devices such as a user equipment (UE) and a BS (BS) operating in various wireless communication systems including 3GPP LTE/LTE-A/5G (or New RAT (NR)).

1. A method of transmitting downlink quality information to a base station (BS) by a user equipment (UE) in a wireless communication system, the method comprising:
transmitting a random access preamble to the BS;
receiving a random access response from the BS; and
transmitting the downlink quality information to the BS through a physical uplink shared channel based on the random access response.

2. The method according to claim 1, wherein the downlink quality information includes information about a required repetition number of a physical downlink control channel related to the random access response that is estimated by the UE for detecting the physical downlink control channel.

3. The method according to claim 1, wherein the downlink quality information includes information about a required aggregation level of a physical downlink control channel related to the random access response that is estimated by the UE for detecting the physical downlink control channel.

4. The method according to claim 2, wherein the UE estimates the required repetition number as the downlink quality information based on an assumption that an aggregation level of the physical downlink control channel is a reference aggregation level.

5. The method according to claim 3, wherein the UE estimates the required aggregation level based on that a repetition number of the physical downlink control channel is 1.

6. The method according to claim 2, wherein the required repetition number is a repetition number required to detect a hypothetical physical downlink control channel at a specific block error rate (BLER).

7. The method according to claim 6, wherein the specific BLER is 1%.

8. The method according to claim 3, wherein the required aggregation level is an aggregation level required to detect the hypothetical physical downlink control channel at a specific block error rate (BLER).

9. The method according to claim 8, wherein the specific BLER is 1%.

10. The method according to claim 1, wherein the downlink quality information is related to either one of a required repetition number of a physical downlink control channel related to the random access response or a required aggregation level of the physical downlink control channel related to the random access response.

11. The method according to claim 1, wherein the random access response includes information indicating the UE to report the downlink quality information.

12. The method according to claim 1, wherein the downlink quality information is transmitted by the UE in a radio resource control (RRC) idle state.

13. The method according to claim 1, wherein the downlink quality information is measured in a common search space (CSS) for a physical downlink control channel related to the random access response.

14. A user equipment (UE) configured to transmit downlink quality information to a base station (BS) in a wireless communication system, the UE comprising:
a radio frequency (RF) transceiver; and
a processor operatively coupled to the RF transceiver,
wherein the processor is configured to transmit a random access preamble to the BS, receive a random access response from the BS, and transmit the downlink quality information to the BS through a physical uplink shared channel based on the random access response, by controlling the RF transceiver.

15. An apparatus for a user equipment (UE) in a wireless communication system, the apparatus comprising:
a memory including instructions; and
a processor operatively coupled to the memory,
wherein the processor is configured to perform specific operations by executing the instructions, and
wherein the specific operations include:
transmitting a random access preamble to a base station (BS);
receiving a random access response from the BS; and
transmitting downlink quality information to the BS through a physical uplink shared channel based on the random access response.

16. A non-transitory processor readable medium recorded thereon instructions for performing the method of claim 1.

17. A method of receiving downlink quality information by a base station (BS) in a wireless communication system, the method comprising:
receiving a random access preamble from a user equipment (UE);
transmitting a random access response to the UE; and
receiving the downlink quality information from the UE through a physical uplink shared channel based on the random access response.

18. A base station (BS) comprising:
a radio frequency (RF) transceiver; and
a processor operatively coupled to the RF transceiver,
wherein the processor is configured to receive a random access preamble from a user equipment (UE), transmit a random access response to the UE, and to receive the downlink quality information from the UE through a physical uplink shared channel based on the random access response.
